(19) United States
(12) Patent Application Publication
(10) Pub. No.: US 2015/0200910 A1
(43) Pub. Date: Jul. 16, 2015

(54) CONTROL APPARATUS AND TRANSFER CONTROL METHOD

(71) Applicant: FUJITSU LIMITED, Kawasaki-shi (JP)

(72) Inventor: Akiko Yamada, Kawasaki (JP)

(21) Appl. No.: 14/564,847

(22) Filed: Dec. 9, 2014

(30) Foreign Application Priority Data
Jan. 10, 2014 (JP) 2014-002852

(51) Int. Cl. H04L 29/12; H04L 12/24

(52) U.S. Cl. CPC H04L 61/2517; H04L 41/0803; H04L 61/10; H04L 61/103

(57) ABSTRACT

A control apparatus includes: a storage in which information indicating a plurality of sets of addresses is stored; and a controller configured to execute a procedure including: obtaining a first address and information on a port that receives first data, from a first switch that receives the first data of which a transmission source is set to be the first address; generating information indicating a correspondence relationship between a set to which the first address belongs, among the plurality of sets, and the port; obtaining a second address from the first switch or a second switch that receives second data of which a destination is set to be the second address that belongs to any one of the plurality of sets; and determining that the second data is output from the port, based on the correspondence relationship.

### CROSS-REFERENCE TO RELATED APPLICATION

This application is based upon and claims the benefit of priority of the prior Japanese Patent Application No. 2014-002852, filed on Jan. 10, 2014, the entire contents of which are incorporated herein by reference.

### FIELD

The embodiments discussed herein are related to a control apparatus and a transfer control method.

### BACKGROUND

Nodes such as computers are connected to one another through a network, and thus data communication between the nodes may be realized. The network includes one or more switches. The switch has ports for data input and output. The network is formed by connecting a node or a different switch to the port of each switch. A switch located between a source node and a destination node transfers data from the source node to the destination node. The switch retains information of the port from which the data is transferred according to a destination of the data and may use the retained information at the time of the data transfer.

For example, there are switches (Layer 3 (L3) switch and the like) that transfer data using Internet Protocol (IP) in the network layer of the Open Systems Interconnection (OSI) reference model. In the IP, with address information called an IP address, each node is identified. For example, in the L3 switch, correspondence between the address information on the destination of data and a port from which the data is transferred is managed with a routing table. The routing table may be fixedly given to the L3 switch (static routing), and may be autonomously generated by each switch using a predetermined routing protocol (dynamic routing).

On the other hand, in recent years, Software-Defined Networking (SDN) has been configured as a method for establishing a communication path using a switch. In SDN, a switch that relays the data and a control apparatus that controls the communication path are separately provided and a destination of the data that is transferred by the switch is determined by the control apparatus. For example, as one among technologies that realize SDN, OPEN FLOW (a registered trademark) is known.

In OPEN FLOW, data to be transferred is distinguished by a unit called a flow. The flow is identified by matching conditions that include a destination address or a transmission source address of the data to be transferred, a combination of these, or the like. The control apparatus assigns to each switch a flow entry in which the matching conditions and an action (transfer, discard, data rewriting, and the like) on the flow are associated with each other, and thus controls the data transfer by each switch. Each switch sends out data, which does not agree with the matching condition that each switch itself retains, to the control apparatus, with the data being included in a message called a packet-in message, and receives an instruction for the action from the control apparatus.

For example, there is a disclosure which suggests that in a system including multiple control apparatuses, multiple switches designate one of the multiple control apparatuses as one determiner that determines the communication path and according to the flow entry assigned by the determiner, received data be relayed. Furthermore, there is also a disclosure which suggests that loads be intensively placed only on some of the switches to suspend a switch not in use and accomplish energy saving.

Examples of the related art are Japanese Laid-open Patent Publications Nos. 2011-160363 and 2013-500654.

### SUMMARY

According to an aspect of the invention, a control apparatus that controls data transfer by a switch having a plurality of ports, the control apparatus includes: a storage in which information indicating a plurality of sets of addresses is stored; and a controller configured to execute a procedure including: obtaining a first address and information on a port that receives first data, from a first switch that receives the first data of which a transmission source is set to be the first address, the port being any one of the plurality of ports; generating information indicating a correspondence relationship between a set to which the first address belongs, among the plurality of sets, and the port; obtaining a second address from the first switch or a second switch that receives second data of which a destination is set to be the second address that belongs to any one of the plurality of sets; and determining that the second data is output from the port, based on the correspondence relationship.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a control apparatus according to a first embodiment;

FIG. 2 is a diagram illustrating an information processing system according to a second embodiment;

FIG. 3 is a diagram illustrating a connection relationship of a switch according to the second embodiment;

FIG. 4 is a diagram illustrating a hardware example of a control server according to the second embodiment;

FIG. 5 is a diagram illustrating a hardware example of the switch according to the second embodiment;

FIG. 6 is a diagram illustrating a functional example of the control server according to the second embodiment;

FIG. 7 is a diagram illustrating a functional example of the switch according to the second embodiment;

FIG. 8 is a diagram illustrating an example of policy information according to the second embodiment;

FIG. 9 is a diagram illustrating an example of an end host table according to the second embodiment;

FIG. 10 is a diagram illustrating an example of an address edge correspondence table according to the second embodiment;

FIG. 11 is a diagram illustrating an example of a flow table according to the second embodiment;

FIG. 12 is a diagram illustrating an example of an ARP frame according to the second embodiment;

FIG. 13 is a diagram illustrating an example of a packet-in message according to the second embodiment;

FIG. 14 is a flowchart illustrating an example of processing that is performed in a case of an ARP request according to the second embodiment;

FIG. 15 is a diagram illustrating an example (an example 1) of the packet-in according to the second embodiment;

FIG. 16 is a diagram illustrating an example of transferring the ARP request according to the second embodiment;

FIG. 17 is a flowchart illustrating an example of processing that is performed in a case of the ARP reply according to the second embodiment;

FIG. 18 is a diagram illustrating an example (an example 2) of packet-in according to the second embodiment;

FIG. 19 is a diagram illustrating an example of a table in the case of the ARP reply according to the second embodiment;

FIG. 20 is a diagram illustrating an example (a continuation example) of the table in the case of the ARP reply according to the second embodiment;

FIG. 21 is a diagram illustrating an example of transferring the ARP reply according to the second embodiment;

FIG. 22 is a flowchart illustrating an example of processing a frame other than ARP according to the second embodiment;

FIG. 23 is a diagram illustrating an example (an example 3) of the packet-in according to the second embodiment;

FIG. 24 is a diagram illustrating an example of a post-update table according to the second embodiment;

FIG. 25 is a diagram illustrating an example (a continuation example) of the post-update table according to the second embodiment;

FIG. 26 is a diagram illustrating an example of transferring the frame according to the second embodiment;

FIG. 27 is a diagram illustrating another example of the flow table according to the second embodiment;

FIG. 28 is a flowchart illustrating a processing example that is performed in the case of the ARP request according to a third embodiment;

FIG. 29 is a diagram illustrating an example of transferring the ARP request according to the third embodiment;

FIG. 30 is a flowchart illustrating an example of processing that is performed in the case of the ARP reply according to the third embodiment;

FIG. 31 is a diagram illustrating an example of transferring the ARP reply according to the third embodiment;

FIG. 32 is a diagram illustrating an example of the flow table according to the third embodiment;

FIG. 33 is a flowchart illustrating a processing example that is performed in the case of the ARP request according to a fourth embodiment;

FIG. 34 is a diagram illustrating an example of transferring the ARP request according to the fourth embodiment;

FIG. 35 is a flowchart illustrating an example of processing that is performed in the case of the ARP reply according to the fourth embodiment;

FIG. 36 is a diagram illustrating an example of transferring the ARP reply according to the fourth embodiment;

FIG. 37 is a diagram illustrating an example of the flow table according to the fourth embodiment;

FIG. 38 is a diagram illustrating an example of a MAC address correspondence table according to the fourth embodiment; and

FIG. 39 is a diagram illustrating an information processing system according to a fifth embodiment.

### DESCRIPTION OF EMBODIMENTS

In SDN, it is considered that data transfer using switches is controlled by a control apparatus. In this case, there occurs a problem of how a transfer destination of a data is set to be in the control apparatus. For example, it is also considered that the user may register the transfer destinations for all addresses that are available as destinations in a fixed manner with the control apparatus. However, it is not easy to understand in advance information on the transfer destinations for all the available addresses and register the transfer destinations. Furthermore, when there is a missing address, communication is not performed in which the destination is set to be a missing address.

On the other hand, it is also considered that the control apparatus collects, from a switch, information on a port that receives data, and learns a correspondence between a node address of a transmission source of the data and a port of the switch. When this is done, if any switch receives the data of which the destination is set to be an address of the already learned node, the control apparatus may determine that the node is present in front of the already learned port. However, in this case, the control apparatus practices learning for every node address. For this reason, the greater the number of nodes, the greater an amount of address learning that the control apparatus practices.

A control apparatus and a transfer control method that may improve efficiency of the address learning, according to embodiments, are described referring to the drawings.

### First Embodiment

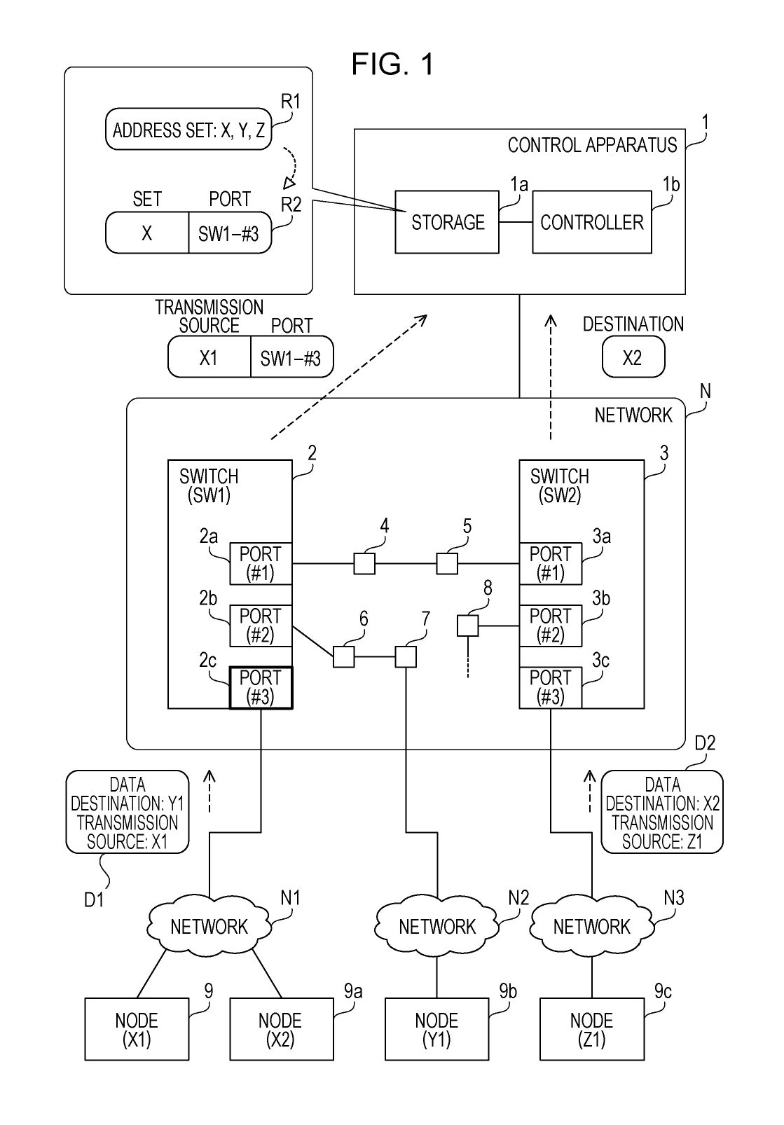

FIG. 1 is a diagram illustrating a control apparatus according to a first embodiment. A control apparatus 1 is connected to a network N. The network N includes switches 2, 3, 4, 5, 6, 7, and 8. The switches 2, 3, 4, 5, 6, 7, and 8 are apparatuses that perform data transfer. The switches 2, 3, 4, 5, 6, 7, and 8 transfer data that is received from any other external network (network N1, N2, N3, or the like) of the network N, to an external network other than the external network from which the data is received.

The switch 2 has ports 2a, 2b, and 2c. The port 2a is connected to the switch 4. The port 2b is connected to the switch 6. The port 2c is connected to the network N1. The switch 3 has ports 3a, 3b, and 3c. The port 3a is connected to the switch 5. The port 3b is connected to the switch 8. The port 3c is connected to the network N3. Furthermore, the switch 4 is connected to the switch 5. The switch 6 is connected to the switch 7. The switch 7 is connected to the network N2. The switch 8 is connected to any other switch or any other network (neither of which is illustrated).

Nodes 9 and 9a are connected to the network N1. A node 9b is connected to the network N2. A node 9c is connected to the network N3. The nodes 9, 9a, 9b, and 9c, for example, are information processing apparatuses, such as computers that perform data communication.

At this point, ports of the switches 2 and 3 are mapped onto port numbers, respectively. The port number of the port 2a is “#1”. The port number of the port 2b is “#2”. The port number of the port 2c is “#3”. The port number of the port 3a is “#1”. The port number of the port 3b is “#2”. The port number of the port 3c is “#3”.

Furthermore, addresses are assigned to the switches 2 and 3 and the nodes 9, 9a, 9b, and 9c, respectively. The address may be an IP address.

The address of the switch 2 is “SW1”. The address of the switch 3 is “SW2”. The address of the node 9 is “X1”. The address of the node 9a is “X2”. The address of the node 9b is “Y1”. The address of the node 9c is “Z1”.

The control apparatus 1 is connected to the switches 2, 3, 4, 5, 6, 7, and 8 through a control network within the network N, and controls the data transfer that is performed by each of the switches 2, 3, 4, 5, 6, 7, and 8. Specifically, according to a destination of data to be transferred, the control apparatus 1 registers a rule indicating the transfer destination of the data to be transferred with the switches 2, 3, 4, 5, 6, 7, and 8. The switches 2, 3, 4, 5, 6, 7, and 8 transfer the data in accordance with the rule.

For example, the control apparatus 1 and the switches 2, 3, 4, 5, 6, 7, and 8 may be network systems that perform the data transfer using an SDN method. The control apparatus 1 may detect in advance a network topology involving the switches 2, 3, 4, 5, 6, 7, and 8, using a Link Layer Discovery Protocol (LLDP).

The control apparatus 1 has a storage is and a controller 1b. The storage is may be a volatile storage device such as a random access memory (RAM), or a nonvolatile storage device such as a hard disk drive (HDD) or a flash memory. The controller 1b, for example, includes a processor. The processor may be a central processing unit (CPU) or a digital signal processor (DSP), and may be an application-specific electrical circuit such as an application specific-integrated circuit (ASIC), or a field programmable gate array (FPGA). Furthermore, the processor may be a set (multiprocessor) of multiple processors. The processor, for example, may be one that executes a program that is stored in the storage 1a.

Information R1 indicating sets of addresses “X, Y, and Z” is stored in the storage 1a. The information R1, for example, may be stored in advance in the storage is by a user. At this point, the set “X” is a set of which members are multiple addresses such as “X1 and X2”. The set “Y” is a set of which members are multiple addresses such as “Y1”. The set “Z” is a set of which members are multiple addresses such as “Z1”.

The controller 1b obtains a first address and the information on the port that receives first data from a first switch that receives the first data of which the transmission source is set to be the first address. When this is done, the controller 1b generates information indicating a correspondence relationship between the set to which the first address belongs, among the sets “X, Y, and Z”, and the port.

For example, data D1 that is destined to the node 9b is set to be transmitted by the node 9. A destination address of the data D1 is “Y1”. A transmission source address of the data D1 is “X1”. The data D1 arrives at the port 2c over the network N1. In this case, the controller 1b obtains from the switch 2 the transmission source address “X1” and information (here, a set “SW1-#3” of identification information on the switch 2 and the port number) on the port 2c. For example, when the transfer destination of the data D1 is not apparent, the switch 2 may transmit the data D1 including the transmission source address “X1” to the control apparatus 1 along with the information on the port 2c.

When this is done, the controller 1b generates information R2 indicating the correspondence relationship between the set “X” to which the transmission source address “X1” belongs and the port 2c. For example, the information R2 indicates the correspondence relationship between the set “X” and identification information “SW1-#3” on the port 2c. The controller 1b stores the information R2 in the storage 1a.

The controller 1b obtains a second address from a second switch that receives second data of which the destination is set to be the second address that belongs to the set which is registered in the information R2. With the correspondence relationship indicated by the information R2, the controller 1b determines that the second data is output from the port that is indicated with the information R2.

For example, data D2 that is destined to the node 9a is set to be transmitted by the node 9c. The destination address of the data D2 is “X2”. The transmission source address of the data D2 is “Z1”. The data D2 arrives at the port 3c over the network N3. In this case, the controller 1b obtains the destination address “X2” from the switch 3. For example, when the transfer destination of the data D2 is not apparent, the switch 3 may transmit the data D2 including the destination address “X2” to the control apparatus 1. When this is done, with the correspondence relationship indicated by the information R2, the controller 1b determines that the data D2 is output from the port 2c. This is because the address “X2” is a member of the set “X”.

For example, the controller 1b may assign to the switches 3, 5, and 4 a rule that the data D2 is transferred toward the switch 2. Specifically, the controller 1b assigns to the switch 3 a rule that data, the destination address “X2”, is output from the port 3a. A rule that the data is output from the port connecting to the switch 4 is assigned to the switch 5. A rule that the data is output from the port connecting to the switch 2 is assigned to the switch 4. Furthermore, the controller 1b assigns to the switch 2 a rule that the data, the destination address “X2”, is output from the port 2c. When this is done, the data D2 is transferred to the node 9a through the switches 3, 5, 4, and 2 and the network N1.

The control apparatus 1 obtains from the switch 2 the transmission source address “X1” of the data D1 and the information on the port 2c that receives the data D1. When this is done, the information R2 is generated that indicates the correspondence relationship between the port 2c and the set “X” to which the address “X1” belongs, among the sets “X, Y, and Z” that are indicated with the information R1 stored in the storage 1a. The control apparatus 1 obtains from the switch 3 the address “X2” that is the destination of the data D2 and that belongs to the set “X”. When this is done, with the correspondence relationship indicated by the information R2, it is determined that the data D2 is output from the port 2c.

Accordingly, the efficiency of the address learning may be improved. Such improvement is described in detail as follows. For example, it is also considered that the control apparatus 1 is made to learn, for every node address, which port of which switch each node is present in front of. For example, it is considered that the control apparatus 1 broadcasts a predetermined inquiry to the networks N1, N2, and N3 in order to learn the correspondence relationship between the node address and the port.

Specifically, it is considered that when the destination address “X2” of the data D2 is set to be the IP address and the IP address of each node belongs to the same subnet, the control apparatus 1 learns which port the address “X2” corresponds to. At this time, it is considered that the control apparatus 1 transfers to the networks N1, N2, and the like an Address Resolution Protocol (ARP) request for resolving a media access control (MAC) address of the IP address “X2”. If the ARP request is obtained from any node, the control apparatus 1 may transfer the ARP request to the networks N1 and N2 and the like.

In this case, if it is not apparent which port of which switch the address “X2” is present in front of, the control apparatus 1 assigns a rule for transferring the ARP request to each network to the switches 2, 3, 4, 5, 6, 7, and 8. When this is done, each switch transfers the ARP request to the networks N1 and N2 and the like. Because the node 9a with the destination IP address “X2” is present in front of the port 2c, the switch 2 receives an ARP reply to the ARP request. The control apparatus 1 obtains a transmission source IP address “X2” of the ARP reply and the information on the port 2c from the switch 2 that receives the ARP reply and thus may learn the correspondence between the IP address “X2” and the port 2c.

However, in this manner, when the learning is practiced for every node address, the greater the number of nodes, the greater the amount of learning that the control apparatus 1 practices. That is, the frequency with which the control apparatus 1 practices the learning or the amount of information that the control apparatus 1 learns increases. When the frequency with which the control apparatus 1 practices the learning increases, a learning load on the control apparatus 1 may increase. Furthermore, when an amount of learned information greatly increases, a storage area such as the storage is may run out of storage space. Furthermore, when the amount of learned information greatly increases, a processing cost for searching the learned information for any entry may increase.

Furthermore, because as described above, an unknown IP address occurs, when the ARP request is transferred to multiple networks outside of the network N, there is a concern that the number of the rules which are assigned to the switches 2, 3, 4, 5, 6, 7, and 8 will greatly increase. This is because a rule for transferring the ARP request to each network is assigned to the switches 2, 3, 4, 5, 6, 7, and 8 for every inquiry target IP address. When the number of the rules that are assigned to each switch greatly increases, the storage area of each switch may run out of storage space. Furthermore, the processing cost for comparing data to be transferred against the rule in each switch may increase.

In contrast, the control apparatus 1 learns, in a unit of each of the sets “X, Y, and Z” that are indicated with the information R1 stored in the storage 1a, which port of which switch the node that has the address that belongs to each set is present in front of, and generates the information R2. Then, for example, if the data D2 of which the destination is set to be the address “X2” that belongs to the set “X” which is registered in the information R2 is received, it is determined that the data D2 is output from the port 2c corresponding to the set “X”. That is, the control apparatus 1 may not learn which port of which switch the node 9a with the address “X2” is present in front of. Consequently, the amount of address learning that the control apparatus 1 practices may be decreased. The decrease in the amount of learning contributes to a decrease in the learning load, storage area saving, and a decrease in the processing cost for searching the learned information.

Furthermore, for example, even though the data D2 is the ARP request, because it may be determined, as described above, that an output destination port of the data D2 is the port 2c, the ARP request is transferred to the switches 3, 5, 4, and 2 and may be output from the port 2c. For this reason, the control apparatus 1 may assign the rule for transferring the ARP request to the switches 3, 5, 4, and 2, and may not assign the rule to the switches 6, 7, and 8. This is because, for example, if it is apparent that the node that has the IP address which belongs to the set “X” is not present in front of the switches 6, 7, and 8, it is unnecessary to assign to the switches 6, 7, and 8 the rule for transferring the ARP request of which the destination (inquiry) IP address is set to be the IP address “X2”. In this manner, the amount of information for the rule that is assigned to each switch may be decreased by not assigning unnecessary rules to each switch. In the case described above, because the switches 6, 7, and 8 end up not performing unnecessary transfer processing, a load on each of the switches 6, 7, and 8 also may be decreased. Furthermore, because the unnecessary ARP request is not broadcast on networks other than the network N1, the load on the network also may be decreased.

Moreover, the user may register with the storage is information on a set that is intended to be learned in advance. For example, in the networks N1, N2, and N3, in a case where an operational restriction that multiple nodes that have adjacent addresses are connected to the same network is present, the set of addresses may be registered with the control apparatus 1 only if the user understands such a restriction. For this reason, not all the addresses that may be used as destinations have to be understood in advance and registered. Consequently, labor saving in a user operation is accomplished.

As described above, the control apparatus 1 may improve the efficiency of the address learning. In addition, the case where in the control apparatus 1, the data D1 and the data D2 are received by the different switches 2 and 3 is described above as an example, but a case where the data D1 and the data D2 are received by the same switch may be controlled in the same manner. For example, a case is considered where in FIG. 1, the network N2 is connected directly (without involving the switches 6 and 7) to a tip of the port 2b and the information R2 indicating the correspondence relationship between the set “X” and the port 2c is stored in the storage 1a. At this time, even though the data of which the destination address is set to be “X2” arrives at the port 2b from the node 9b, the controller 1b may perform the processing in the same manner as when the data D2 arrives at the port 3c. That is, the controller 1b obtains the destination address “X2” from the switch 2 and may determine that the data which arrives at the port 2b is output from the port 2c.

### Second Embodiment

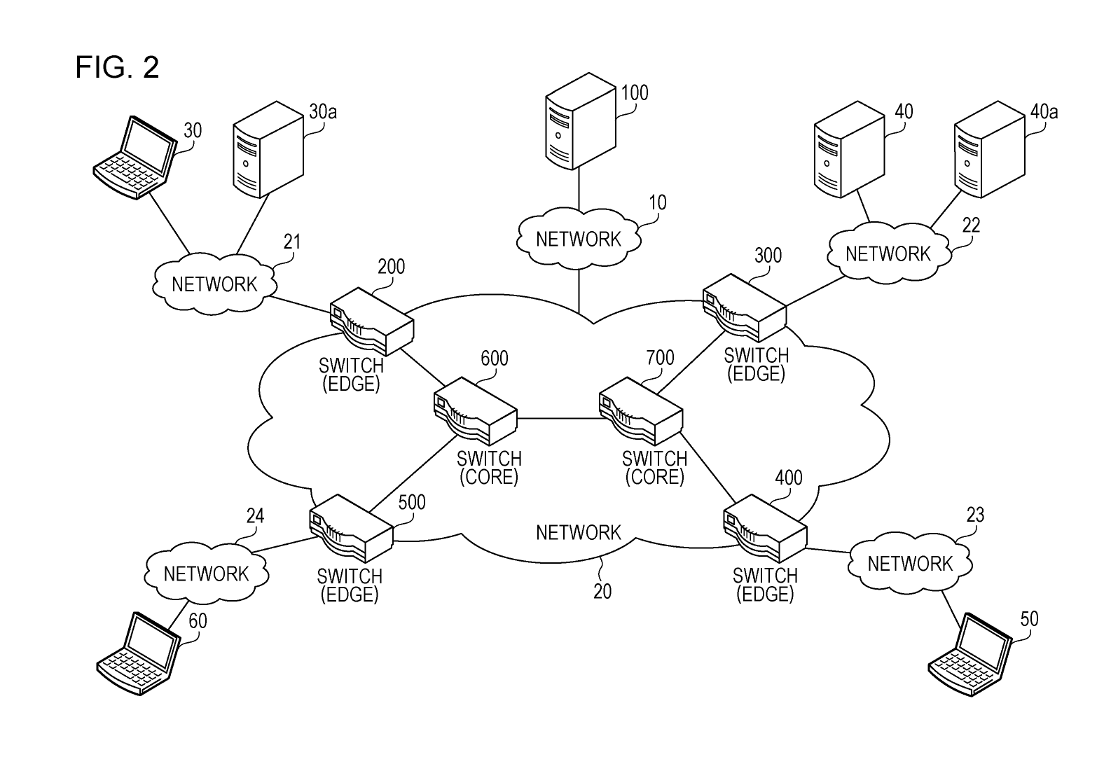

FIG. 2 is a diagram illustrating an information processing system according to a second embodiment. The information processing system according to the second embodiment includes clients 30, 50, and 60, and servers 30a, 40, and 40a, a control server 100, and switches 200, 300, 400, 500, 600, and 700. The control server 100 and the switches 200, 300, 400, 500, 600, and 700 perform data transfer using OPEN FLOW.

The clients 30, 50, and 60 are client computers that are used by the users. The servers 30a, 40, and 40a are server computers that provide a predetermined service to the clients 30, 50, 60, and the like. The clients 30, 50, and 60 and the servers 30a, 40, and 40a are hereinafter referred to as “end hosts” in description.

The control server 100 is a server computer that controls the data transfer using switches 200, 300, 400, 500, 600, and 700. The control server 100 is connected to a network 10. The network 10 is a control network (control plane). The switches 200, 300, 400, 500, 600, and 700 are also connected to the network 10. The control server 100 may communicate with the switches 200, 300, 400, 500, 600, and 700 through the network 10. The control server 100 is one example of the control apparatus 1 according to the first embodiment.

The switches 200, 300, 400, 500, 600, and 700 are apparatuses that perform the data transfer according to an instruction from the control server 100. The switches 200, 300, 400, 500, 600, and 700 make up a network 20. For example, the switches 200, 300, 400, 500, 600, and 700 are connected to one another through a predetermined cable and thus a communication path is formed that connects between each switch. The network 20 is a data transfer network (data plane).

At this point, the network 20 is connected to networks 21, 22, 23, and 24. The networks 21, 22, 23, and 24 are user networks. The client 30 and the server 30a are connected to the network 21. The servers 40 and 40a are connected to the network 22. The client 50 is connected to the network 23. The client 60 is connected to the network 24.

Furthermore, the switch 200 is connected to the switch 600 and the network 21. The switch 300 is connected to the switch 700 and the network 22. The switch 400 is connected to the switch 700 and the network 23. The switch 500 is connected to the switch 600 and the network 24. The switch 600 is connected to the switches 200, 500, and 700. The switch 700 is connected to the switches 300, 400, and 600.

Because the switches 200, 300, 400, and 500 belong to the network 20, and are arranged in borders between the network 20 and each of the networks 21, 22, 23, and 24, respectively, the switches 200, 300, 400, and 500 may be called edge switches or edges. In contrast, because the switches 600 and 700 form a trunk communication path within the network 20, not in the borders, the switches 600 and 700 may be called core switches. In addition, the switches 200, 300, 400, 500, 600, and 700 are hereinafter expressed as “each switch” in description.

At this point, communication interfaces between the clients 30, 50, and 60, and the servers 30a, 40, and 40a are identified with MAC addresses, respectively. The clients 30, 50, and 60, and the servers 30a, 40, and 40a retain their respective IP addresses with their respective IP addresses associated with their respective MAC addresses.

Furthermore, the information processing system according to the second embodiment is assumed to be based on an L2 network (flat network). That is, a network address for the IP address that is assigned to the clients 30, 50, and 60 and the servers 30a, 40, and 40a is set to be the same. When an attempt is made to communicate with a different end host, a certain end host recognizes that an IP address of the different end host belongs to the network address in which the IP address of the different end host is the same as its own IP address.

Moreover, in the networks 21, 22, 23, and 24, an operational policy in which multiple end hosts which have adjacent IP addresses (for example, several high-order bits of one IP address are the same as those of another) are connected to the same network is present.

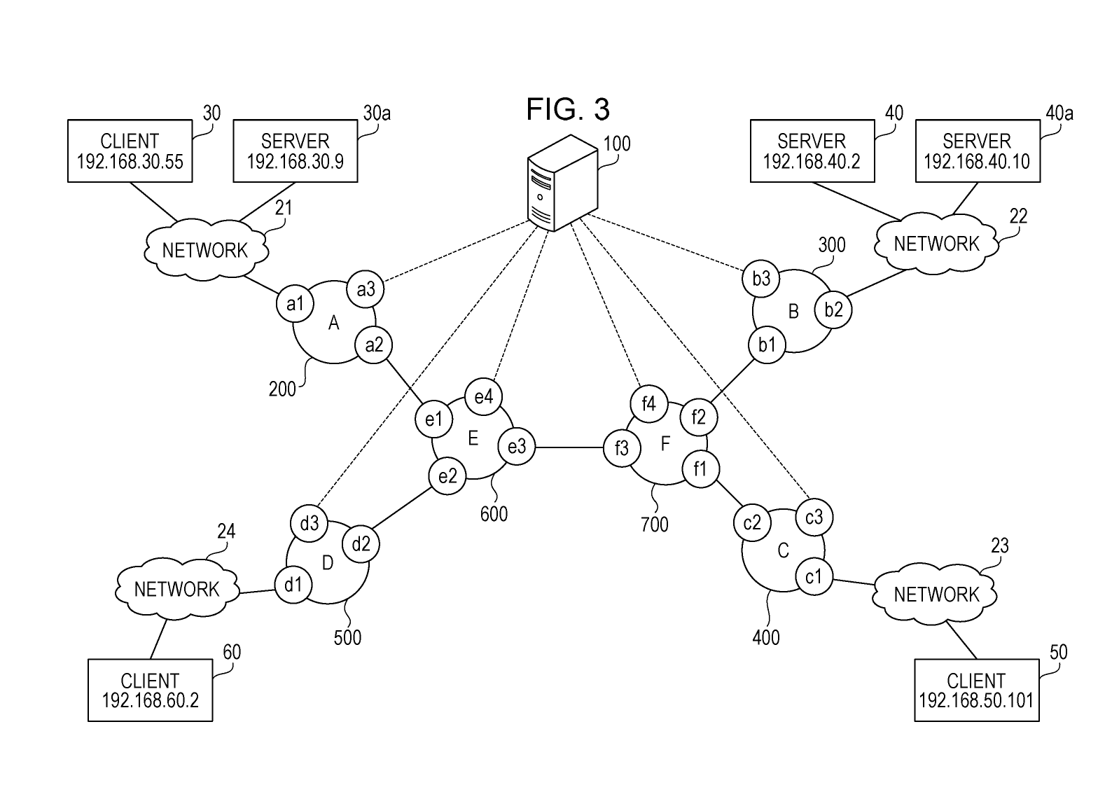

FIG. 3 is a diagram illustrating a connection relationship of the switch according to the second embodiment. FIG. 3 illustrates the connection relationship between communication ports that are provided in each switch. A port number is assigned to the ports of each switch.

The switch 200 has the ports of which the port numbers are “a1”, “a2”, and “a3”, respectively. The switch 300 has the ports of which the port numbers are “b1”, “b2”, and “b3”, respectively. The switch 400 has the ports of which the port numbers are “c1”, “c2”, and “c3”, respectively. The switch 500 has the ports of which the port numbers are “d1”, “d2”, and “d3”, respectively. The switch 600 has the ports of which the port numbers are “e1”, “e2”, “e3”, and “e4”, respectively. The switch 700 has the ports of which the port numbers are “f1”, “f2”, “f3”, and “f4”, respectively.

Here, a letter string of “port” and a port number in combination hereinafter express each port in description. For example, if a port has a port number “a1”, the port is expressed as “port a1”. A specific connection relationship between the ports of each switch is as follows.

A port a1 is connected to the network 21. A port b2 is connected to the network 22. A port c1 is connected to the network 23. A port d1 is connected to the network 24.

Furthermore, sets of ports that follow are connected to one another: the ports a2 and e1, the ports b1 and f2, the ports c2 and f1, the ports d2 and e2, and the ports e3 and f3. Moreover, the ports a3, b3, c3, d3, e4, and f4 are connected to the control server 100 through the network 10 (this connection relationship is indicated by a dotted line in the drawing). The control server 100 may understand the network topology including the connection relationship between the ports of each switch using a predetermined protocol (LLDP or Open Shortest Path First (OSPF)).

FIG. 3 also illustrates the identification information that is assigned to each switch. The identification information on the switch 200 is “A”. The identification information on the switch 300 is “B”. The identification information on the switch 400 is “C”. The identification information on the switch 500 is “D”. The identification information on the switch 600 is “E”. The identification information on the switch 700 is “F”. The identification information may be the MAC address or the IP address, or the like of the port that is connected to the network 10 of each switch.

Furthermore, FIG. 3 also illustrates the IP addresses of the clients 30, 50, and 60, and the servers 30a, 40, and 40a. The IP address of the client 30 is “192.168.30.55”. The IP address of the server 30a is “192.168.30.9”. The IP address of the server 40 is “192.168.40.2”. The IP address of the server 40a is “192.168.40.10”. The IP address of the client 50 is “192.168.50.101”. The IP address of the client 60 is “192.168.60.2”.

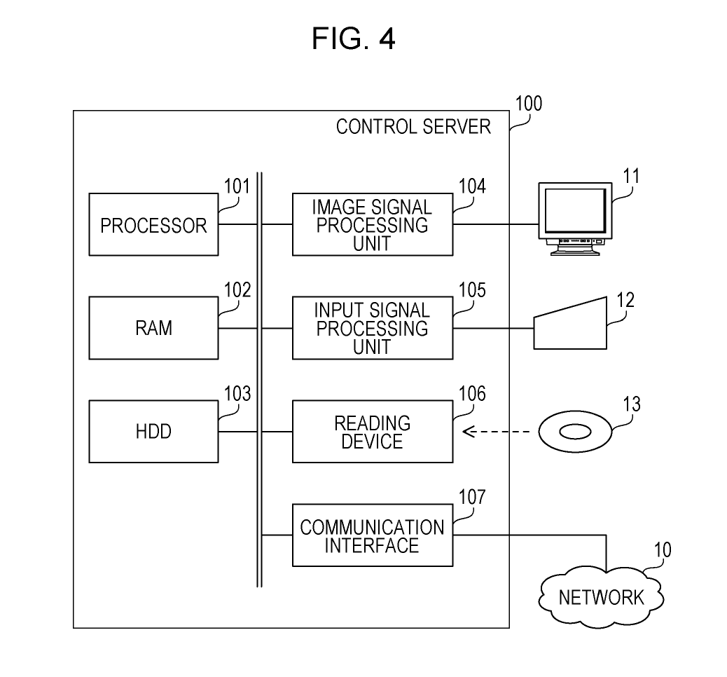

FIG. 4 is a diagram illustrating a hardware example of a control server according to the second embodiment. The control server 100 has a processor 101, a RAM 102, an HDD 103, an image signal processing unit 104, an input signal processing unit 105, a reading device 106, and a communication interface 107. Each unit is connected to a bus of the control server 100.

The processor 101 controls the entire control server 100. The processor 101 may be a multiprocessor. The processor 101 is, for example, a CPU, a DSP, an ASIC, an FPGA, or the like. The processor 101 may be a combination of two or more elements, among the CPU, the DSP, the ASIC, the FPGA, and the like.

The RAM 102 is a main storage device of the control server 100. At least one portion of a program or an application program for an operating system (OS) that is executed by the processor 101 is temporarily stored on the RAM 102. Furthermore, various items of data that are used for processing by the processor 101 are stored on the RAM 102.

The HDD 103 is an auxiliary storage device of the control server 100. The HDD 103 performs magnetic writing and reading of the data on a built-in magnetic disk. The programs and the application programs for the OS, and the various items of data are stored on the HDD 103. The control server 100 may include any type of auxiliary storage device such as a flash memory or a solid state drive (SSD) and may include multiple auxiliary storage devices.

According to a command from the processor 101, the image signal processing unit 104 outputs an image to a display 11 that is connected to the control server 100. As the display 11, various displays can be used such as a cathode ray tube (CRT) display, a liquid crystal display (LCD), and an electro-luminescence (EL) display.

The input signal processing unit 105 obtains an input signal from an input device 12 that is connected to the control server 100, and outputs the input signal to the processor 101. As the input device 12, various input devices may be used such as a pointing device such as a mouse or a touch panel, a keyboard, and a button switch. Furthermore, multiple types of input devices may be connected to the control server 100.

The reading device 106 is a reading device that reads a program or data that is stored on the recording medium 13. As the recording medium 13, for example, a magnetic disk such as a flexible disk (FD) or an HDD, an optical disk such as a compact disc (CD), or a digital versatile disc (DVD), and a magneto-optical (MO) disk may be used. Furthermore, as the recording medium 13, for example, a non-volatile semiconductor memory may be used such as a flash memory card. According to the command from the processor 101, the reading device 106, for example, stores on the RAM 102 or on the HDD 103 the program or the data that is read from the recording medium 13.

The communication interface 107 communicates with a different apparatus (for example, each switch) through the network 10.

The clients 30, 50, and 60, and the servers 30a, 40, and 40a also may be realized by the same hardware as the control server 100.

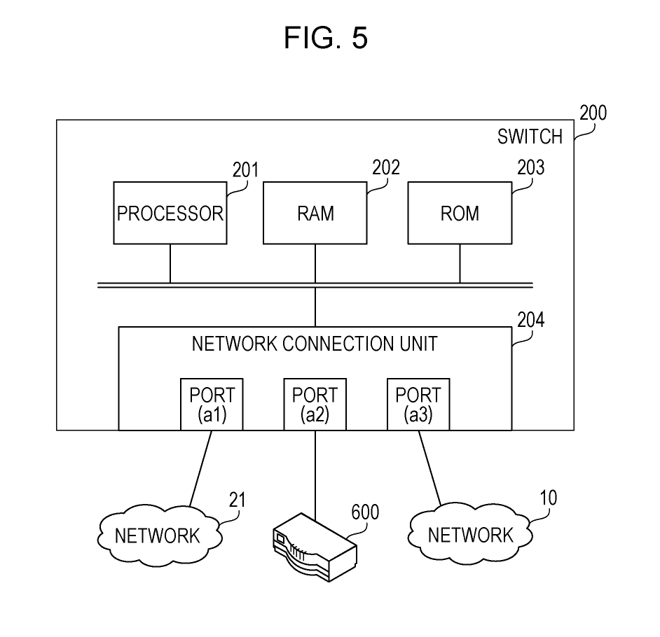

FIG. 5 is a diagram illustrating a hardware example of the switch according to the second embodiment. The switch 200 has a processor 201, a RAM 202, a Read Only Memory (ROM) 203, and the network connection unit 204. Each unit is connected to a bus of the switch 200.

The processor 201 controls the entire switch 200. The processor 201 may be a multiprocessor. The processor 201, for example, is a CPU, an MPU, a DSP, an ASIC, or an FPGA. The processor 201 may be a combination of two or more elements among the CPU, MPU, DSP, ASIC, and FPGA.

The RAM 202 is a main storage device of the switch 200. At least one portion of a firmware program that is executed by the processor 201 is temporarily stored on the RAM 202. Furthermore, various items of data that are used for the processing by the processor 201 are stored on the RAM 202.

The firmware program or the data is stored in advance on the ROM 203. The ROM 203 may be a rewritable non-volatile memory such as a flash memory. The program or the data that is stored on the ROM 203 is used for the processing by the processor 201.

The network connection unit 204 is a communication interface that is used for the data transfer. The network connection unit 204 includes the ports a1, a2, and a3. As described above, the port a1 is connected to the network 21. The port a2 is connected to the switch 600. The port a3 is connected to the network 10. The network connection unit 204 outputs to the processor 201 data that is input into the ports a1, a2, and a3. Furthermore, the network connection unit 204 outputs the data from the ports a1, a2, and a3 according to an instruction from the processor 201.

The switches 300, 400, 500, 600, and 700 can be realized by the same hardware as the switch 200.

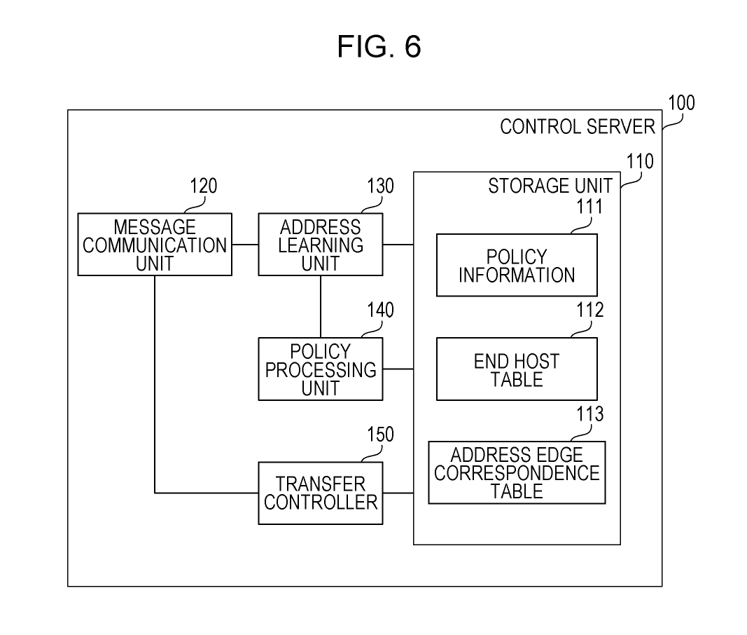

FIG. 6 is a diagram illustrating a functional example of the control server according to the second embodiment. The control server 100 has a storage unit 110, a message communication unit 120, an address learning unit 130, a policy processing unit 140, and a transfer controller 150. The storage unit 110 may be realized using the storage area that is secured in the RAM 102 or the HDD 103. The message communication unit 120, the address learning unit 130, the policy processing unit 140, and transfer controller 150 may be modules of a program that is executed by the processor 101.

Information that is used for processing by each unit of the control server 100 is stored in the storage unit 110. The information that is stored in the storage unit 110 includes policy information 111, an end host table 112, and an address edge correspondence table 113.

The policy information 111 is information for specifying an IP address space (a set of IP addresses) that is present under the control of the same edge (outside of the network 20). The end host table 112 is information indicating the correspondence relationship between learned edge information, the IP address, and the MAC address. At this point, the edge information is a combination of the switch and the port, and is information that identifies any port of each switch. The address edge correspondence table 113 is information that indicates the correspondence relationship between the edge information and the IP address space. In addition, information (the IP address, the MAC address, or the like of the port connected to the network 10, of each switch) that is used for the communication with each switch is also stored in the storage unit 110.

The message communication unit 120 transmits and receives various messages between the message communication unit 120 and each switch. Specifically, the message communication unit 120 receives a packet-in message from each switch. The packet-in message is a message for transmitting to the control server 100 data that arrives at each switch. The packet-in message includes the pieces of information on the switch of the transmission source and on the port through which the switch of the transmission source receives the data. The message communication unit 120 outputs the received packet-in message to the address learning unit 130 or the transfer controller 150.

Furthermore, the message communication unit 120 transmits a packet-out message or a flow-mod message to each switch. The packet-out message is a message for transmitting to the switch the data that is obtained with the packet-in message. The flow-mod message is a message for assigning a flow entry to each switch. The packet-out message or the flow-mod message is generated by the transfer controller 150. Transmission and reception of the message by the address learning unit 130 or the transfer controller 150 is described below as being performed through the message communication unit 120.

The address learning unit 130 learns the correspondence between the IP address of the host computer, the MAC address, and the edge information. The address learning unit 130 obtains the data to be transferred from the packet-in message. The address learning unit 130 searches the address edge correspondence table 113 for the edge information that corresponds to the IP address space to which the transmission source IP address that is included in the data to be transferred belongs. If the edge information is difficult to find, the correspondence relationship between the transmission source IP address, the transmission source MAC address that is included in the data to be transferred, and the edge information is generated and is registered in the end host table 112. If the address edge correspondence table 113 is searched and as a result some edge information may be found, the address learning unit 130 does nothing.

When a new entry is added to the end host table 112 by the address learning unit 130, based on a policy registered in the policy information 111, the policy processing unit 140 specifies which IP address space the learned IP address belongs to. The policy processing unit 140 generates information that indicates the correspondence relationship between the specified IP address space and the edge information learned by the address learning unit 130, and registers the generated information in the address edge correspondence table 113.

According to the destination IP address of data that is included in the packet-in message, the transfer controller 150 determines the transfer destination of the data. At that time, the transfer controller 150 uses the address edge correspondence table 113. Specifically, the transfer controller 150 searches the address edge correspondence table 113 for the edge information corresponding to the IP address space to which the destination IP address belongs. The transfer controller 150 determines that the data is sent out from the port of the edge that is indicated with the edge information. The edge that is indicated with the edge information sends out the data from the network 20 to an external network, and thus may be called an end point edge within the network 20.

At this point, the transfer controller 150 may detect the communication path leading to the end point edge from the transmission source edge (hereinafter referred to as a transmission source edge of packet-in) of the packet-in message. At this point, the transmission source edge of the packet-in is a starting point of the communication path within the network 20, and thus may be called a start point edge. The transfer controller 150, as described above, obtains in advance information on the network topology involving each switch using LLDP, OSPF, or the like, and stores the obtained information in the storage unit 110. In this case, with the information on the network topology that is stored in the storage unit 110, the communication path leading to the end point edge may be understood from the transmission source edge (start point edge) of the packet-in. In addition, if multiple candidates for the communication path are present, a Dijkstra method or the like is applied to a graph indicating the network topology, and thus a shortest path may be selected.

The transfer controller 150 assigns the flow entry for transferring the data to the end point edge to the switch present on the detected communication path. Furthermore, the transfer controller 150 assigns to the end point edge the flow entry for outputting the data from the port that is indicated with the edge information. The flow-mod message, as described above, is used for the assigning of the flow entry. The transfer controller 150 transmits the packet-out message to the transmission source edge (start point edge) of the packet-in, and transfers the data.

With the packet-in message, the transfer controller 150 receives the ARP request. In such a case, the transfer controller 150 searches the address edge correspondence table 113 for the edge information corresponding to the IP address space to which the destination (inquiry) IP address that is included in the ARP request belongs. If any edge information may be found, as described above, the transfer controller 150 determines that the ARP request is sent out from the port of the edge that is indicated with the edge information. On the other hand, if any edge information is difficult to find, the ARP request is transferred to the networks 21, 22, 23, and 24 (the network to which the end host of the transmission source of the ARP request belongs is excluded, and this is hereinafter true). That is, in this case, the transfer controller 150 determines that the ARP request is sent out from the port connecting to the networks 21, 22, 23, and 24 that have the multiple edges.

FIG. 7 is a diagram illustrating a functional example of the switch according to the second embodiment. The switch 200 has a storage unit 210, a message communication unit 220, and a transfer processing unit 230. The storage unit 210 may be realized using the storage area that is secured in the RAM 202. The message communication unit 220 and the transfer processing unit 230 may be modules of a program that is executed by the processor 201.

Information that is used for processing by the transfer processing unit 230 is stored in the storage unit 210. The information that is stored in the storage unit 210 includes a flow table 211. The flow table 211 is information in which the flow entry indicating the correspondence relationship between a matching condition specifying a flow and a processing method (action) is stored. At this point, the flow is a unit that distinguishes the data to be transferred. The flow, for example, is specified by the transmission source IP address, the destination IP address, a destination MAC address, and the like, or by the matching condition that is obtained by combining these. In addition, the information (MAC address or the IP address of the communication interface 107) that is used for the communication with the control server 100 is also stored in the storage unit 210.

The message communication unit 220 transmits and receives various messages between the message communication unit 220 and the control server 100. Specifically, the message communication unit 220 transmits the packet-in message to the control server 100. The packet-in message is generated by the transfer processing unit 230. The transmission and reception of the message by the transfer processing unit 230 is described below as being performed through the message communication unit 220.

Furthermore, the message communication unit 220 receives from the control server 100 various messages such as the packet-out message or the flow-mod message. The message communication unit 220 outputs the received packet-out message or flow-mod message to the transfer processing unit 230.

The transfer processing unit 230 transfers the data based on the flow table 211. Furthermore, when data of which the destination IP address is unknown (the data that does not agree with any matching condition in the flow table 211) is received from the network 21, the transfer processing unit 230 generates the packet-in message including the data and thus transmits the generated packet-in message to the control server 100.

When the flow-mod message is received from the control server 100, according to instruction details of the flow-mod message, the transfer processing unit 230 updates the flow table 211 that is stored in the storage unit 210. The transfer processing unit 230 transfers the received data based on the flow table 211 that is stored in the storage unit 210.

Furthermore, when the packet-out message is received from the control server 100, according to the flow entry that is registered in the flow table 211, the transfer processing unit 230 transfers the data that is included in the packet-out message. According to the action within the packet-out message, the transfer processing unit 230 processes the data that is included in the packet-out message.

The switches 300, 400, 500, 600, and 700 also have the same function as the switch 200.

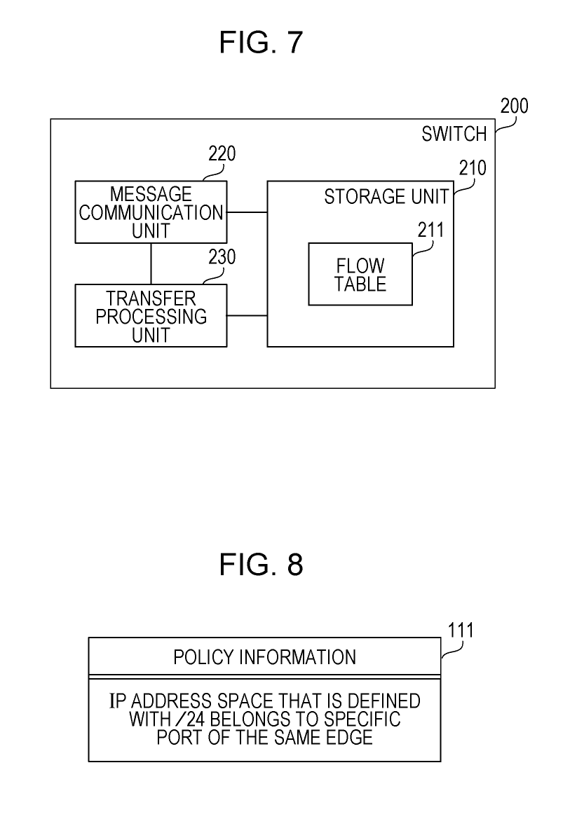

FIG. 8 is a diagram illustrating an example of the policy information according to the second embodiment. The policy information 111 is information for specifying the multiple IP address spaces that are present under the control of the same edge (outside of the network 20). The policy information 111 may be information that determines a method of allocating the IP address space. For example, information “IP address space that is defined with /24 belongs to a specific port of the same edge” is registered in the policy information 111. This indicates that each IP address space (set of IP addresses) of which high-order 24 bits of the IP address are the same belongs to a specific port of the same edge.

This is one example, and an arbitrary policy may be registered in the policy information 111 by the user. For example, as the policy information 111, a range of multiple IP addresses may be explicitly assigned, in such a manner that “IP addresses: 192.168.100.1 to 192. 168.100.100 belong to a specific port of the same edge” or “IP addresses: 192.168.100.101 to 192.168.100.200 belong to a specific port of the same edge”. Furthermore, in addition to the range of consecutive values as described above, it is considered that a set of IP addresses that includes inconsecutive values (for example, “192.168.100.101”, “192.168.100.103”, and the like) as members, may also be assigned.

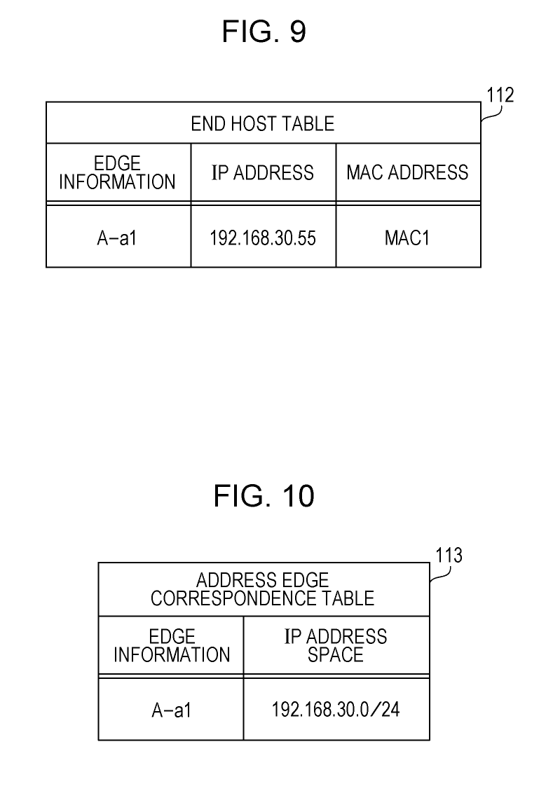

FIG. 9 is a diagram illustrating an example of the end host table according to the second embodiment. The end host table 112 includes items that are the edge information, the IP address and the MAC address. The information that identifies the port of the switch is registered under the edge information item. The IP address of the end host is registered under the IP address item. The MAC address of the end host is registered under the MAC address item.

For example, pieces of information that are the edge information “A-a1”, the IP address “192.168.30.55”, and the MAC address “MAC1” are registered in the end host table 112. At this point, a MAC address “MAC1” is the MAC address of the communication interface that is included in the client 30 (hereinafter shortened to the “MAC address of the client 30”). The entry indicates that that client 30 that has the IP address “192.168.30.55” and the MAC address “MAC1” is present in front of the port a1.

FIG. 10 is a diagram illustrating an example of the address edge correspondence table according to the second embodiment. The address edge correspondence table 113 includes items that are the edge information and the IP address space. The information that identifies the port of the switch is registered under the edge information item. The information that indicates the IP address space is registered under the IP address space item.

For example, pieces of information that are the edge information “A-a1”, and the IP address space “192.168.30.0/24” are registered in the address edge correspondence table 113. This indicates that the end host which has the IP address that belongs to the IP address space “192.168.30.0/24” is present in front of the port a1.

Based on the policy information 111 and the entry of the end host table 112, the policy processing unit 140 may generate the address edge correspondence table 113. That is, an IP address space allocation policy (policy information 111) is assigned in advance, and conversion is performed in which the policy is considered in addition to the correspondence information (end host table 112) that is obtained with an existing method (for example, the same method as with a known learning switch).

Specifically, the IP address “192.168.30.55” that is registered in the end host table 112 is converted to the “IP address space ‘192.168.30.0/24’ of which the high-order 24 bits are the same”, which is indicated with the policy. Then, the IP address space “192.168.30.0/24” is associated with the edge information “A-a1” of the IP address “192.168.30.55” that is registered in the end host table 112, and thus the entry of the address edge correspondence table 113 may be generated.

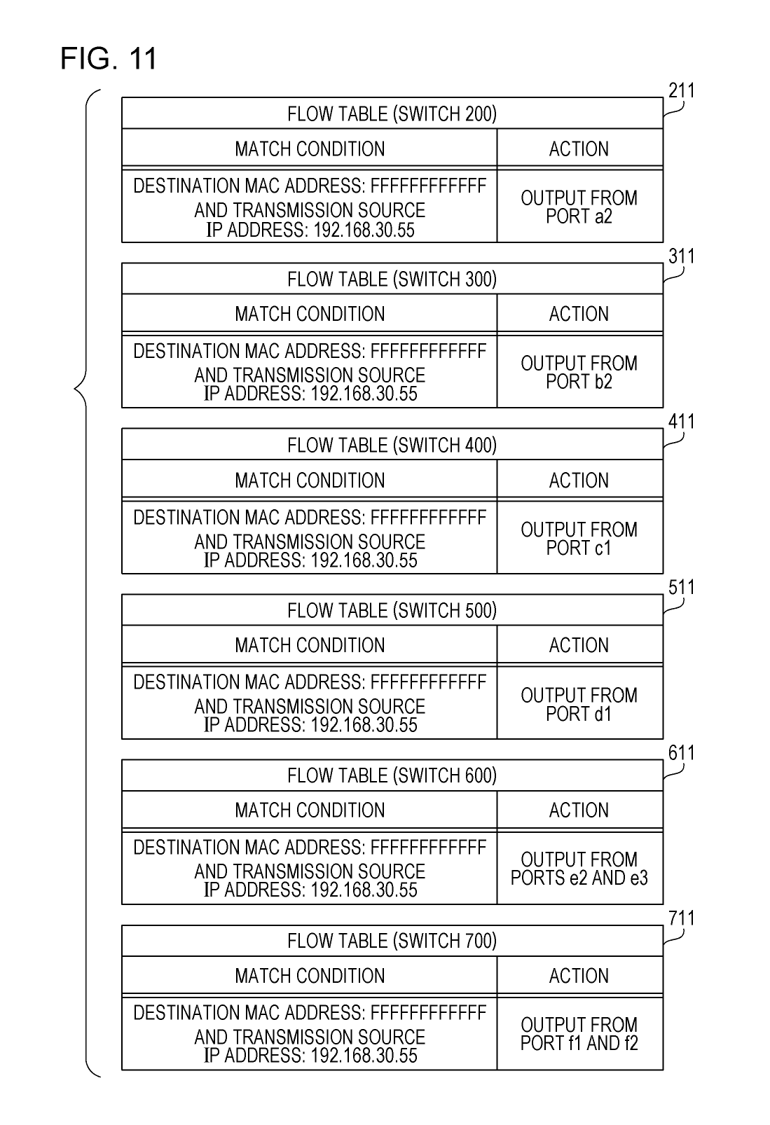

FIG. 11 is a diagram illustrating an example of a flow table according to the second embodiment. FIG. 11 illustrates flow tables 211, 311, 411, 511, 611, and 711 for transferring the ARP request transmitted by the client 30 from the switch 200 to the networks 22, 23, and 24. However, the flow entry that is indicated here is one example, and may vary with a situation of the communication among the end hosts.

The flow table 211, as described above, is retained by the switch 200. The flow table 311, as described above, is retained by the switch 300. The flow table 411, as described above, is retained by the switch 400. The flow table 511, as described above, is retained by the switch 500. The flow table 611, as described above, is retained by the switch 600. The flow table 711, as described above, is retained by the switch 700.

The flow tables 211, 311, 411, 511, 611, and 711 each include the items of the matching condition and the action. The matching condition for specifying the flow is registered under the matching condition item. The action indicating processing on the flow is registered under the item of the action item.

For example, the flow entry, such as the matching condition “destination MAC address: FFFFFFFFFFFF and transmission source IP address: 192.168.30.55”, and the action “output from the port a2”, is registered in the flow table 211.

If the destination MAC address and the transmission source IP that are included in data to be transferred are “FFFFFFFFFFFF” and “192.168.30.55”, respectively, the flow entry is a flow entry for outputting the data to be transferred from the port a2. In addition, the destination MAC address “FFFFFFFFFFFF” is a broadcast address in a data link layer. The flow entry, as described below, is based on the assumption that the ARP request is present.

The same matching condition is registered in the flow tables 311, 411, 511, 611, and 711. However, the action varies from one switch to another. Furthermore, other pieces of information (for example, the number of times that the matching condition is satisfied, and the like) may be registered in the flow table of each switch.

When the packet-in message is newly received, if the address edge correspondence table 113 is referred to, but the entry of the IP address space that includes the destination IP address of a frame within the packet-in message is not present in the address edge correspondence table 113, in order to obtain the edge information corresponding to the destination IP address, the transfer controller 150 generates the entry for causing the packet-in message to arrive finally at each edge, which is illustrated in FIG. 11, and assigns the generated entry to the flow table of each switch.

On the other hand, when the packet-in messages is newly received, if the address edge correspondence table 113 is referred to and as a result, the entry of the IP address space that includes the destination IP address of the frame within the packet-in message is present in the address edge correspondence table 113, the transfer controller 150 assigns to the flow table of each switch the entry for causing the packet-in message to arrive finally at the edge, which is obtained.

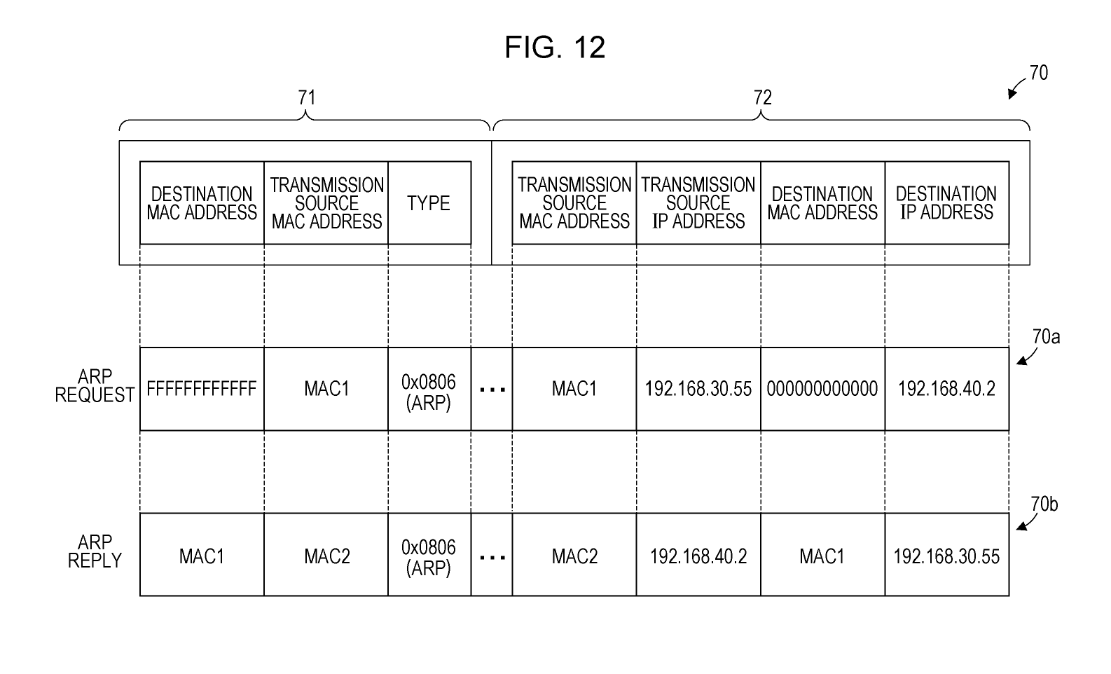

FIG. 12 is a diagram illustrating an example of an ARP frame according to the second embodiment. Data that is communicated among the end hosts is transmitted and received in a unit called a frame in the data link layer (or Ethernet (a registered trademark)) of the OSI reference model. The data to be transferred is described below by being referred to as the frame. A frame 70 illustrates the ARP frame.

The frame 70 includes a MAC header 71 and an ARP packet 72. The MAC header 71 is a header area of the frame 70. The MAC header 71 includes a destination MAC address field, a transmission source MAC address field, and a type field.

The destination MAC address is assigned under the destination MAC address field. The transmission source MAC address is assigned under the transmission source MAC address field. The Ethernet type is assigned under the type field.

The ARP packet 72 is an area in which pieces of information on the transmission source (inquiry source) and the destination (inquiry destination) of the ARP are stored. At this point, the packet is a communication unit in a network layer (or IP) of the OSI reference model. The ARP packet 72 includes the items that are the transmission source MAC address, the transmission source IP address, the destination MAC address, and the destination IP address.

The destination MAC address is assigned under the destination MAC address field. The transmission source IP address is assigned under the transmission source IP address field. The destination MAC address is assigned under the destination MAC address field. The destination IP address is assigned under the destination IP address field.

FIG. 12 illustrates an ARP request 70a and an ARP reply 70b as well. The ARP request 70a is an ARP request that is transmitted by the client 30. For example, the destination MAC address “FFFFFFFFFFFF” (broadcast address in the data link layer), the transmission source MAC address “MAC1”, and the type “0x0806” (which indicates the ARP) are assigned to the MAC header of the ARP request 70a. The transmission source MAC address “MAC1”, the transmission source IP address “192.168.30.55”, the destination MAC address “000000000000”, and the destination IP address “192.168.40.2” are assigned to the ARP packet of the ARP request 70a. That is, the ARP request 70a is an ARP request that inquires the MAC address corresponding to the IP address “192.168.40.2” (server 40).

Furthermore, the ARP reply 70b is an ARP reply that the server 40 transmits in response to the ARP request 70a. For example, a destination MAC address “MAC1”, a transmission source MAC address “MAC2”, and a type “0x0806” are assigned to a MAC header in the ARP reply 70b. At this point, the MAC address “MAC2” is a MAC address of the server 40. Furthermore, the transmission source MAC address “MAC2”, the transmission source IP address “192.168.40.2”, the destination MAC address “MAC1”, and the destination IP address “192.168.30.55” are assigned to the ARP packet in the ARP reply 70b.

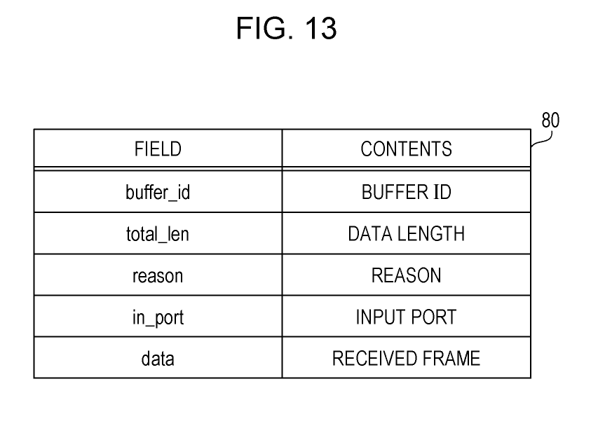

FIG. 13 is a diagram illustrating an example of the packet-in message according to the second embodiment. A packet-in message 80 is used to transmit the frame received by each switch to the control server 100. For example, the packet-in message 80 includes a buffer_id field, a total_len field, a reason field, an in_port field, and a data field.

A buffer ID that identifies a buffer in which the frame is stored if the received frame is buffered in the switch is assigned to the buffer_id field. If the frame is not buffered, for example, the buffer ID is set to “−1”. A description is provided below on the assumption that the buffering is not performed in each switch.

A data length of the frame is assigned to the total_len field. The reason for transmitting the packet-in message is assigned to the reason field. Specifically, reasons are provided such as “A flow entry that matches is not present”, “the flow entry is assigned in such a manner that the frame in the flow is transmitted to the control server 100”, and so forth.

The port number of the port (input port) that receives the frame is assigned to the in_port field. For example, if it is assumed that the switch 200 receives the ARP request 70a from the network 21, the port at the network 21 side is the port a1 among the ports a1, a2, and a3. Therefore, if the switch 200 transmits the ARP request 70a to the control server 100, the port number “a1” is assigned to the in_port field of the packet-in message.

The message in the received frame is assigned to the data field. For example, if the switch 200 transmits the ARP request 70a to the control server 100, the entire ARP request 70a or one portion (portion that is used for processing in the control server 100) of the ARP request 70a is assigned to the data field of the packet-in message.

In addition, various messages such as the packet-in message are encapsulated in the packet to be sent out. Consequently, for example, with the transmission IP address (IP address of the switch) of the IP header and the like, the control server 100 may identify the switch of the transmission source.

Next, processing operations by the control server 100 are described. At this point, according to the second embodiment, it is assumed that the L2 network is present. That is, when an attempt is made to communicate with a different end host over the network 20, the end host recognizes that an IP address of the different end host also belongs to the same network address (or the subnet) as the end host itself. Consequently, in order to resolve the MAC address of the different end host, the end host transmits the ARP request. Accordingly, first, the processing operations are illustrated in a case where with the packet-in message, the control server 100 obtains the ARP request.

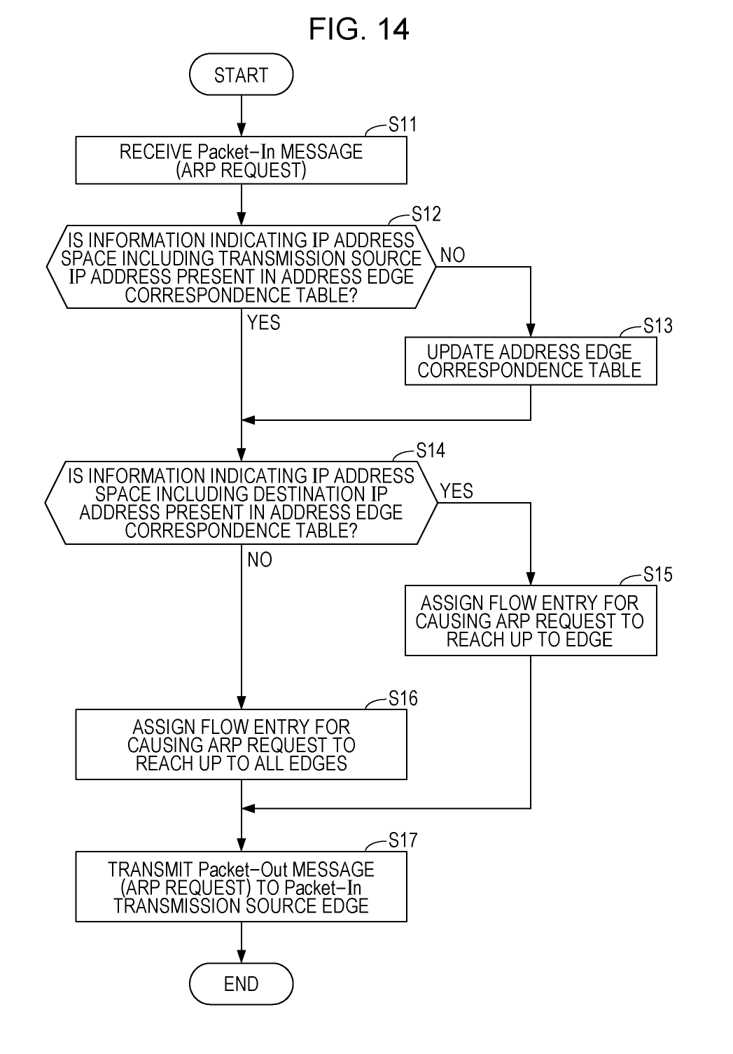

FIG. 14 is a flowchart illustrating a processing example that is performed in a case of an ARP request, according to the second embodiment. The processing illustrated in FIG. 14 is described below in order of increasing operation number. In addition, before an operation S11 is first performed, no information is set to be registered in the end host table 112, the address edge correspondence table 113, and the flow table of each switch.

The operation S11 is described below. The message communication unit 120 receives the packet-in message from any edge. The packet-in message includes the ARP request. The address learning unit 130 and the transfer controller 150 obtain the packet-in message (ARP request) from the message communication unit 120.

An operation S12 is described below. The address learning unit 130 refers to the address edge correspondence table 113, and thus determines whether or not information indicating the IP address space including the transmission source IP address of the obtained ARP request is present. If such information is not present, the processing proceeds to an operation S13. If such information is present, the processing proceeds to an operation S14.

The operation S13 is described below. The address learning unit 130 generates information indicating the correspondence relationship between the transmission source IP address of the obtained ARP request, the transmission source MAC address, and the edge information that is specified from the packet-in message, and adds the generated information to the end host table 112. Based on the policy information 111 and the information added to the end host table 112, the policy processing unit 140 adds a new entry to the address edge correspondence table 113. For example, if the ARP request 70a is received, the entry is added as follows. The policy information 111 indicates “IP address space that is defined with “/24” belongs to a specific port of the same edge”. At this time, the transmission source IP address of the ARP request 70a is “192.168.30.55”. Consequently, the IP address space of which the high-order 24 bits are common is expressed as “192.168.30.0/24” (the IP address is converted to the IP address space). Furthermore, as described above, the edge information with which the ARP request 70a is received may be specified as “A-a1” (which is equivalent to the port a1 of the switch 200) from the packet-in message. Consequently, the policy processing unit 140 generates information indicating the correspondence relationship between the edge information “A-a1” and the IP address space “192.168.30.0/24”, and adds the generated information to the address edge correspondence table 113. Then, the processing proceeds to an operation S14.

The operation S14 is described below. The transfer controller 150 refers to the address edge correspondence table 113 and thus determines whether or not information indicating the IP address space including the destination IP address of the obtained ARP request is present. If such information is present, the processing proceeds to an operation S15. If such information is not present, the processing proceeds to an operation S16.

The operation S15 is described below. The transfer controller 150 obtains from the address edge correspondence table 113 the edge information corresponding to the IP address space, which is searched for in the operation S14. The transfer controller 150 specifies the switches to pass through before arriving finally at the edge (end point edge) corresponding to the edge information from the transmission source edge (start point edge) of the packet-in. As described above, the transfer controller 150 may specify the switch from the information on the network topology that is stored in the storage unit 110. The transfer controller 150 assigns to each specified switch the flow entry for causing the ARP request to arrive at the end point edge from the start point edge. The transfer controller 150 uses the flow-mod message in the assignment of the flow entry to each switch (this is hereinafter true). At this time, the transfer controller 150 performs the assigning on the end point edge in such a manner that the ARP request is output from the port that is specified with the edge information. Then, the processing proceeds to an operation S17.

The operation S16 is described below. The transfer controller 150 assigns to each switch the flow entry for causing the ARP request to arrive at all the edges other than the transmission source edge of the packet-in. At this time, the transfer controller 150 performs the assignment on each target edge in such a manner that the ARP request is output from the port that is connected to the network that is outside of the network 20 (in directions of the networks 21, 22, 23, and 24). Then, the processing proceeds to the operation S17.

The operation S17 is described below. The transfer controller 150 transmits the packet-out message including the obtained ARP request to the transmission source edge of the packet-in through the message communication unit 120. According to the flow entry that is assigned in the operation S15 or the operation S16, the edge that receives the packet-out message transfers the ARP request that is included in the packet-out message. According to the assigned flow entry, other switches also transfer the ARP request.

In addition, the control server 100 may execute the operations S12 and S13 after the operations S14 to S17 or in parallel with the operations S14 to S17.

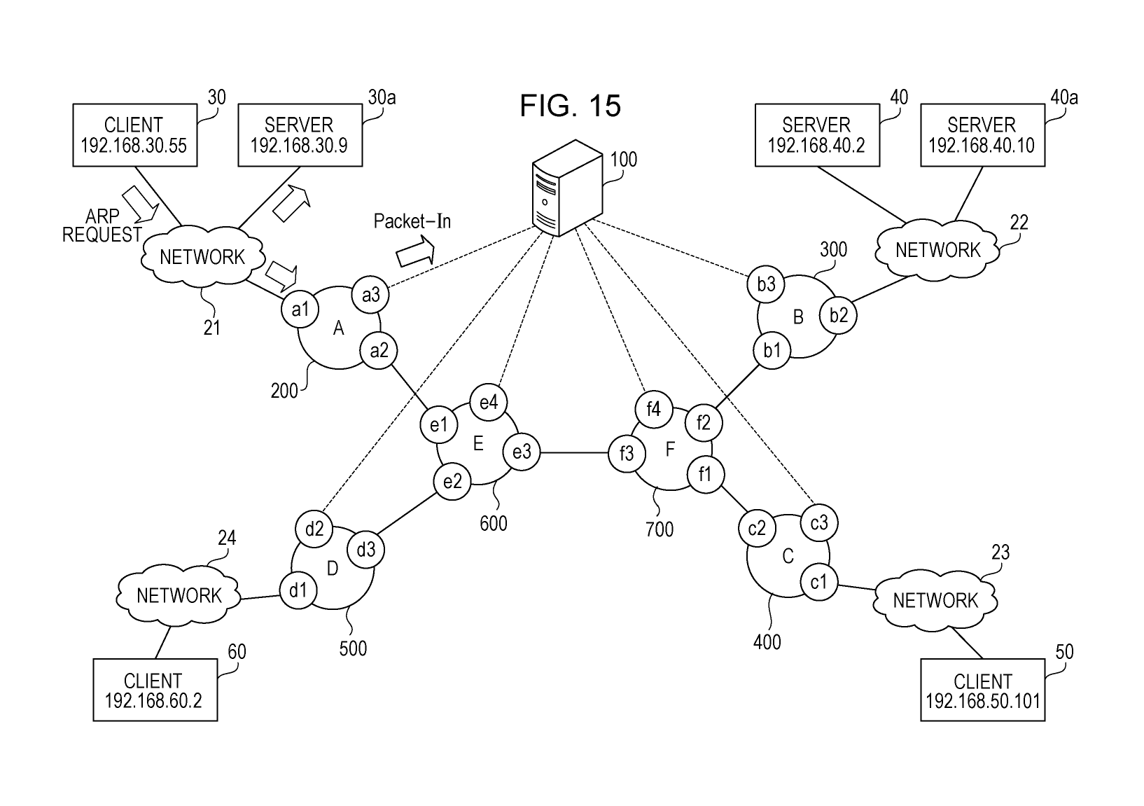

FIG. 15 is a diagram illustrating an example (an example 1) of the packet-in according to the second embodiment. In FIG. 15, it is assumed that the ARP request 70a is transmitted from the client 50. Furthermore, no information is set to be registered in the end host table 112, the address edge correspondence table 113, and the flow table of each switch.

The ARP request 70a is broadcast within the network 21 as well, and arrives at the server 30a and the port a1. The server 30a ignores the ARP request 70a. This is because the destination IP address of the ARP request 70a is not the IP address of the server 30a.

Because the switch 200 does not retain the flow entry that is consistent with the ARP request 70a, the switch 200 transmits the packet-in message including the ARP request 70a to the control server 100.

When this is done, the control server 100 detects that the IP address space “192.168.30.0/24” is present in front of the port a1 of the switch 200. The control server 100 registers the correspondence relationship between the edge information “A-a1” and the IP address space “192.168.30.0/24” in the address edge correspondence table 113.

Moreover, the control server 100 refers to the address edge correspondence table 113 and thus detects that the information indicating the IP address space including the destination IP address “192.168.40.2” of the ARP request 70a is not registered. For this reason, the control server 100 assigns to each switch the flow entry for transferring the ARP request 70a to the networks 22, 23, and 24. For example, the matching condition for specifying the ARP request 70a is set to be “destination MAC address: FFFFFFFFFFFF and transmission source IP address: 192.168.30.55”.

The action varies from one switch to another. In the switch 200, a designated output port is the port a2. In the switch 600, the designated output ports are the ports e2 and e3. In the switch 500, the designated output port is the port d1. In the switch 700, the designated output ports are the ports f1 and f2. In the switch 300, the designated output port is the port b2. In the switch 400, the designated output is the port c1.

FIG. 11 illustrates a result of assigning these flow entries to the flow table of each switch. Thereafter, the control server 100 transmits to the switch 200 the packet-out message including the ARP request 70a.

In addition, if the ARP request 70a is buffered at the switch 200 side, the control server 100 may not include the ARP request 70a in the packet-out message. In such a case, in the packet-in message, the control server 100 causes the switch to assign the buffer ID. Then, with the packet-out message, the control server 100 may give an instruction to transfer the ARP request 70a stored in the buffer ID.

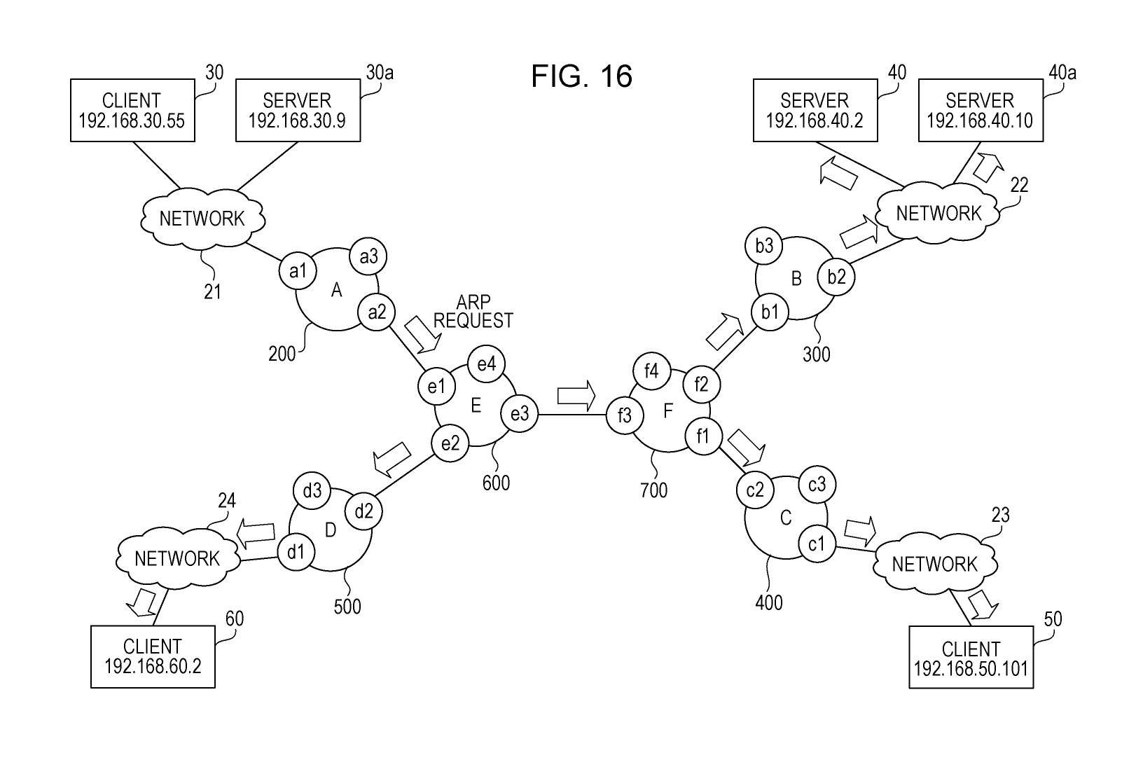

FIG. 16 is a diagram illustrating an example of transferring the ARP request according to the second embodiment. FIG. 16 illustrates a situation where the ARP request 70a is transferred based on the flow table of each switch illustrated in FIG. 11. The switch 200 outputs the ARP request 70a from the port a1. The switch 600 receives the ARP request 70a at the port e1. The switch 600 copies the ARP request 70a and outputs the copied ARP request 70a from the ports e2 and e3.

The switch 500 receives the ARP request 70a at the port d2. The switch 500 outputs the ARP request 70a from the port d1. The switch 700 receives the ARP request 70a at the port f3. The switch 700 copies the ARP request 70a and outputs the copied ARP request 70a from the ports f1 and f2.

The switch 300 receives the ARP request 70a at the port b1. The switch 300 outputs the ARP request 70a from the port b2. The switch 400 receives the ARP request 70a at the port c2. The switch 400 outputs the ARP request 70a from the port c1.

In this manner, the ARP request 70a arrives at the networks 22, 23, and 24. The networks 22, 23, and 24 broadcast the ARP request 70a. The clients 50 and 60 and the server 40, even though they receive the ARP request 70a, ignore them. This is because the destination IP address that is included in the ARP request 70a is not the IP addresses of the clients 50 and 60 and the server 40a. When the ARP request 70a is received, the server 40 generates the ARP reply 70b to respond to the ARP request 70a. This is because the destination IP address that is included in the ARP request 70a is the IP address of the server 40.

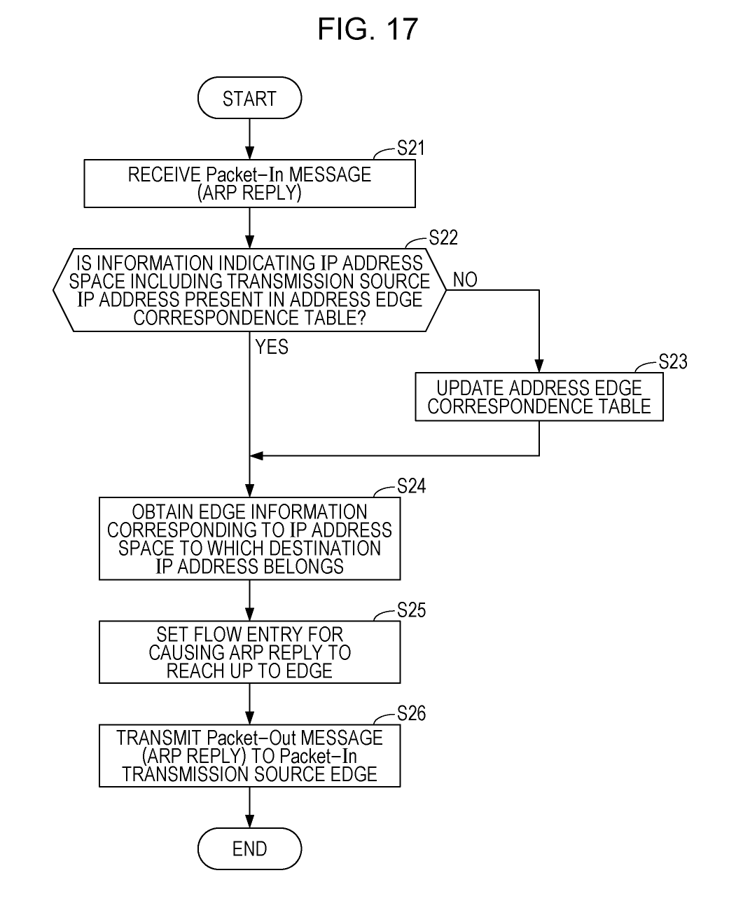

FIG. 17 is a flowchart illustrating an example of processing that is performed in a case of an ARP reply according to the second embodiment. The processing illustrated in FIG. 17 is described below in order of increasing operation number.

An operation S21 is described below. The message communication unit 120 receives the packet-in message from any edge. The packet-in message includes the ARP reply. The address learning unit 130 and the transfer controller 150 obtain the packet-in message (ARP reply) from the message communication unit 120.

An operation S22 is described below. The address learning unit 130 refers to the address edge correspondence table 113 and thus determines whether or not information indicating the IP address space including the transmission source IP address of the obtained ARP reply is present. If such information is not present, the processing proceeds to an operation S23. If such information is present, the processing proceeds to an operation S24.

The operation S23 is described below. The address learning unit 130 generates information indicating the correspondence relationship between the transmission source IP address of the obtained ARP reply, the transmission source MAC address, and the edge information that is specified from the packet-in message, and adds the generated information to the end host table 112. Based on the policy information 111 and the information added to the end host table 112, the policy processing unit 140 adds a new entry to the address edge correspondence table 113. For example, if the ARP reply 70b is received, in the same manner as in the operation S13, information indicating the correspondence relationship between the edge information “B-b2” and the IP address space “192.168.40.0/24” is generated and is added to the address edge correspondence table 113. Then, the processing proceeds to an operation S24.

The operation S24 is described below. The transfer controller 150 refers to the address edge correspondence table 113 and thus obtains the edge information corresponding to the IP address space to which the destination IP address of the ARP reply belongs. Because the ARP reply is transmitted in response to the ARP request, with the ARP request that occurs earlier, the IP address space to which the destination IP address of the ARP reply belongs has to be registered in the address edge correspondence table 113. However, when the IP address space is not registered, this may result from a communication error.

An operation S25 is described below. The transfer controller 150 specifies the switches to pass through before arriving finally at the edge (end point edge) corresponding to the edge information obtained in the operation S24 from the transmission source edge (start point edge) of the packet-in. A specification method is as described in the operation S15. The transfer controller 150 assigns to each specified switch the flow entry for causing the ARP reply to arrive at the end point edge from the start point edge. At this time, the transfer controller 150 performs the assignment on the end point edge in such a manner that with the edge information, the ARP reply is output from the specified port.

An operation S26 is described below. The transfer controller 150 transmits the packet-out message including the obtained ARP reply to the transmission source edge of the packet-in through the message communication unit 120. According to the flow entry that is assigned in the operation S25, the edge that receives the packet-out message transfers the ARP reply that is included in the packet-out message. According to the assigned flow entry, other switches also transfer the ARP reply.

In addition, the control server 100 may execute the operations S22 and S23 after the operations S24 to S26 or in parallel with the operations S24 to S26.

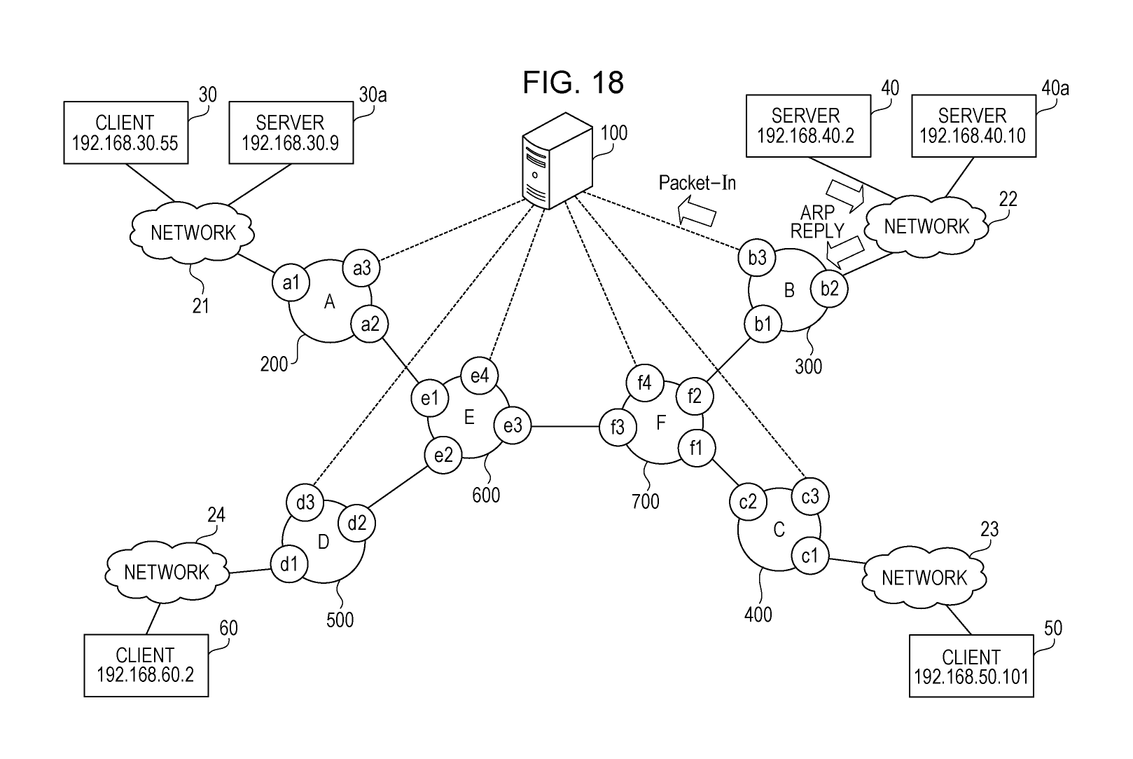

FIG. 18 is a diagram illustrating an example (an example 2) of the packet-in according to the second embodiment. In FIG. 18, in addition to the assumption in FIG. 16, it is assumed that the ARP reply 70b is transmitted from the server 40.

The ARP reply 70b is transmitted in a unicast manner. The ARP reply 70b arrives at the port b2 over the network 22. Because the switch 300 does not retain the flow entry that is consistent with the ARP reply 70b, the switch 300 transmits the packet-in message including the ARP reply 70b to the control server 100.

When this is done, the control server 100 detects that the IP address space “192.168.40.0/24” is present in front of the port b2 of the switch 300. The control server 100 registers the correspondence relationship between the edge information “B-b2 and the IP address space “192.168.40.0/24” in the address edge correspondence table 113.

Moreover, the control server 100 refers to the address edge correspondence table 113 and thus detects that the information indicating the IP address space “192.168.30.0/24” including the destination IP address “192.168.30.55” of the ARP reply 70b, has been registered. The control server 100 determines that the ARP reply 70b is output (that is, is transferred to the network 21) from the port a1 (which is equivalent to the edge information “A-a 1”) of the switch 200 corresponding to the IP address space.

Then, the control server 100 assigns the flow entry for transferring the ARP reply 70b to the network 21 to the switches 200, 300, 600, and 700. For example, the matching condition for specifying the ARP reply 70b is set to be “destination IP address: 192.168.30.55”. The action varies from one switch to another. In the switch 300, the designated output port is the port b1. In the switch 700, the designated output port is the port f3. In the switch 600, the designated output port is the port e1. In the switch 200, the designated output port is the port a1. At this point, the post-update address edge correspondence table 113 and the post-update flow table of each switch are as follows.

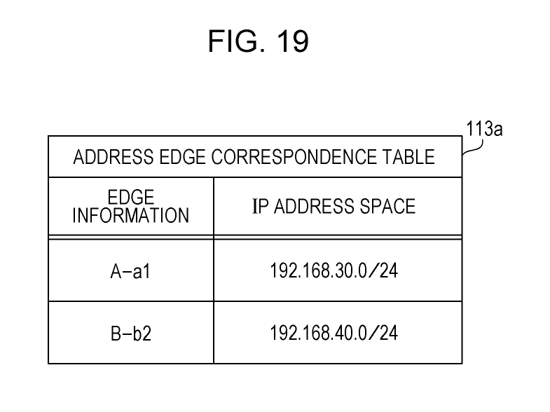

FIG. 19 is a diagram illustrating an example of the table in the case of the ARP reply according to the second embodiment. An address edge correspondence table 113a illustrates the post-update address edge correspondence table 113. The information indicating the correspondence relationship between the edge information “B-b2” and the IP address space “192.168.40.0/24” is added to the address edge correspondence table 113a.

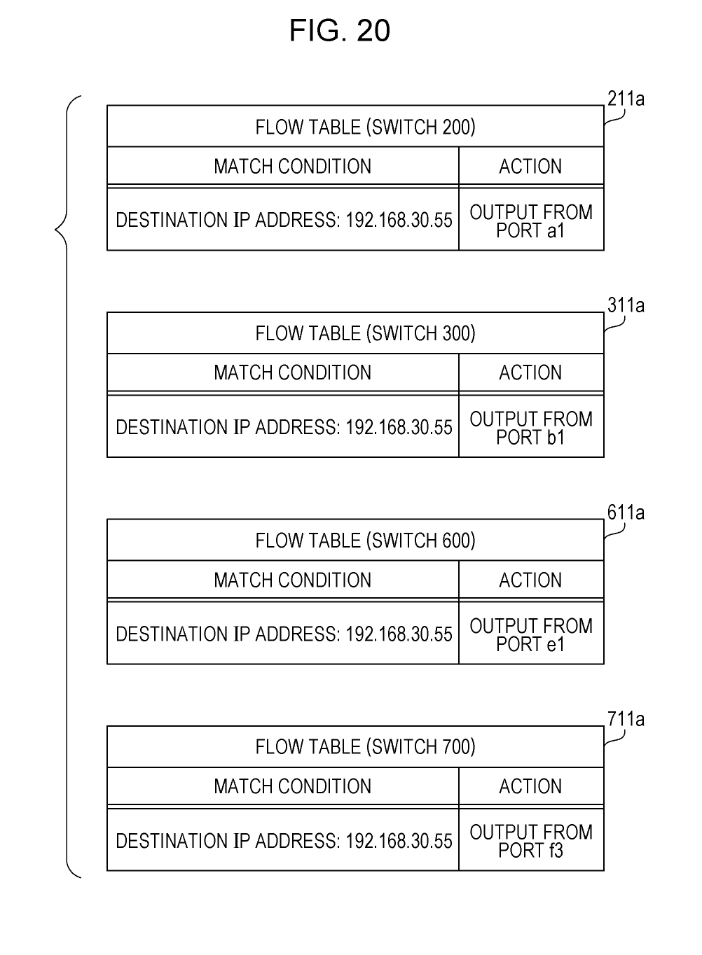

FIG. 20 is a diagram illustrating an example (a continuation example) of the table in the case of the ARP reply according to the second embodiment. Flow tables 211a, 311a, 611a, and 711a illustrate the post-update flow tables 211, 311, 611, and 711, respectively. However, in FIG. 20, only the added flow entry is illustrated (illustrating of other flow entries is omitted).

In any case, the matching condition of the added flow entry is commonly “destination IP address: 192. 168.30.55”. On the other hand, the action varies from one flow table after another. In the flow table 211a, the action is “output from the port a1”. In the flow table 311a, the action is “output from the port b1”. In the flow table 611a, the action is “output from the port e1”. In the flow table 711a, the action is “output from the port f3”.

Thereafter, the control server 100 transmits the packet-out message including the ARP reply 70b to the switch 300.

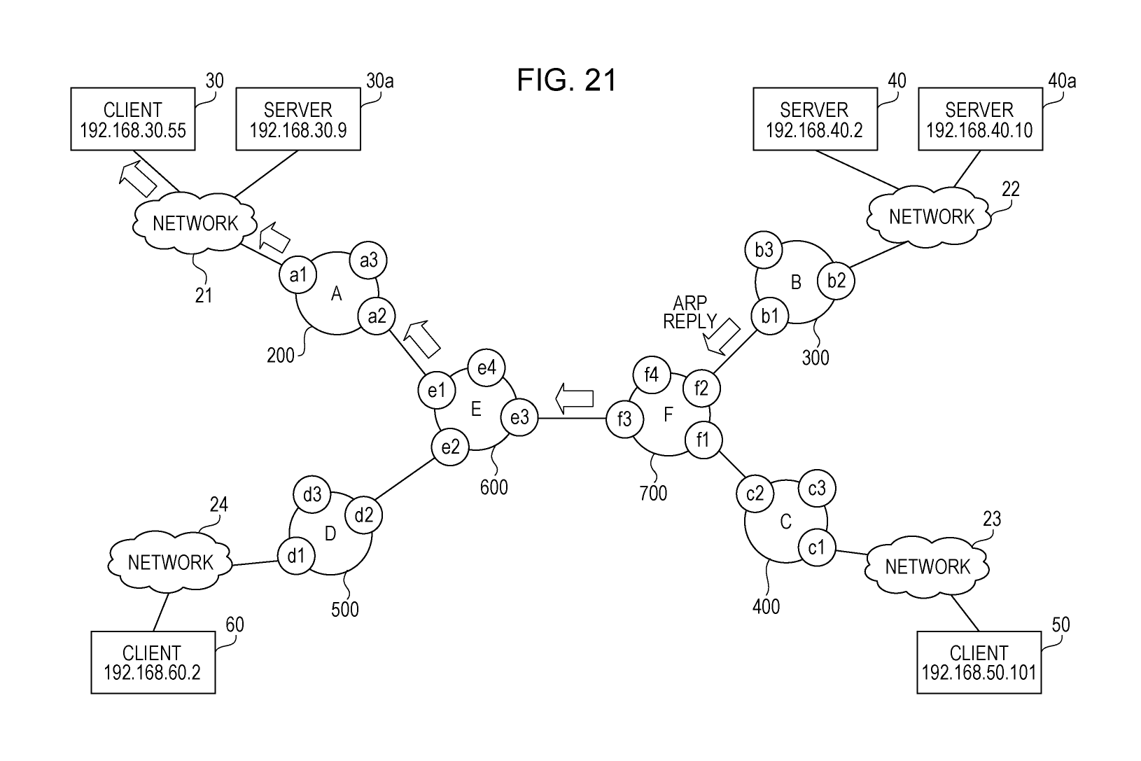

FIG. 21 is a diagram illustrating an example of transferring the ARP reply according to the second embodiment. FIG. 21 illustrates a situation where the ARP reply 70b is transferred based on the flow table of each switch illustrated in FIG. 20. The ARP reply 70b is transferred from the switch 300 to the network 21 through the switches 700, 600, and 200 in this order. Thereafter, the ARP reply 70b is transferred to the client 30 over the network 21 based on the destination MAC address “MAC1”. The client 30 may specify the transmission source MAC address “MAC2” that is included in the ARP reply 70b, as the MAC address corresponding to the IP address “192.168.40.2”.

In addition, thereafter, for example, it is considered that the ARP request that inquires the MAC address for the destination IP address “192.168.30.9” (IP address of the server 30a) is transmitted from the server 40. In this case, the switch 300 receives the ARP request and transmits the ARP request to the control server 100 using the packet-in message.

At this time, the correspondence relationship between the edge information “A-a1” and the IP address space “192.168.30.0/24” is registered in the address edge correspondence table 113a. Consequently, the control server 100 determines that the ARP request is output from the port a1 of the switch 200. In this case, the control server 100 assigns the flow entry for the transfer from the switch 300 to the switch 200 to the switches 300, 700, and 600, and assigns the flow entry for the outputting from the port a1 to the switch 200 (the processing in the operation S15 in FIG. 14). On the other hand, the control server 100 does not transfer the ARP request to the switches 400 and 500. For this reason, the ARP request is broadcast to the network 21, but is not broadcast to the networks 23 and 24. Next, the processing operations on a frame other than the ARP by the control server 100 are described.

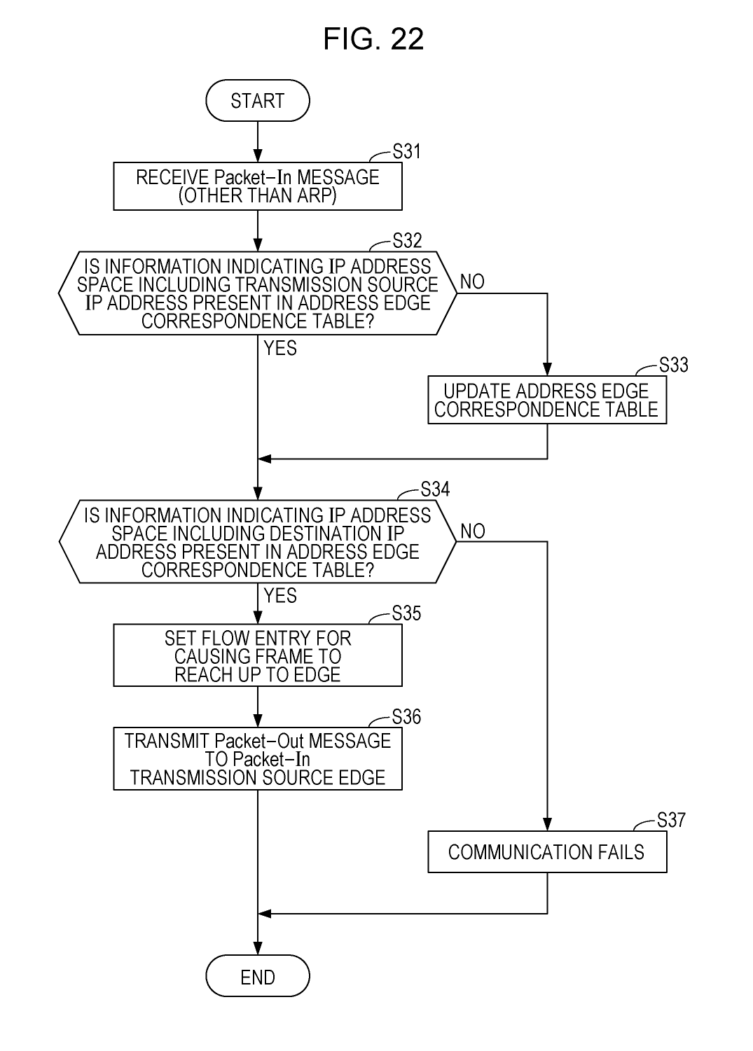

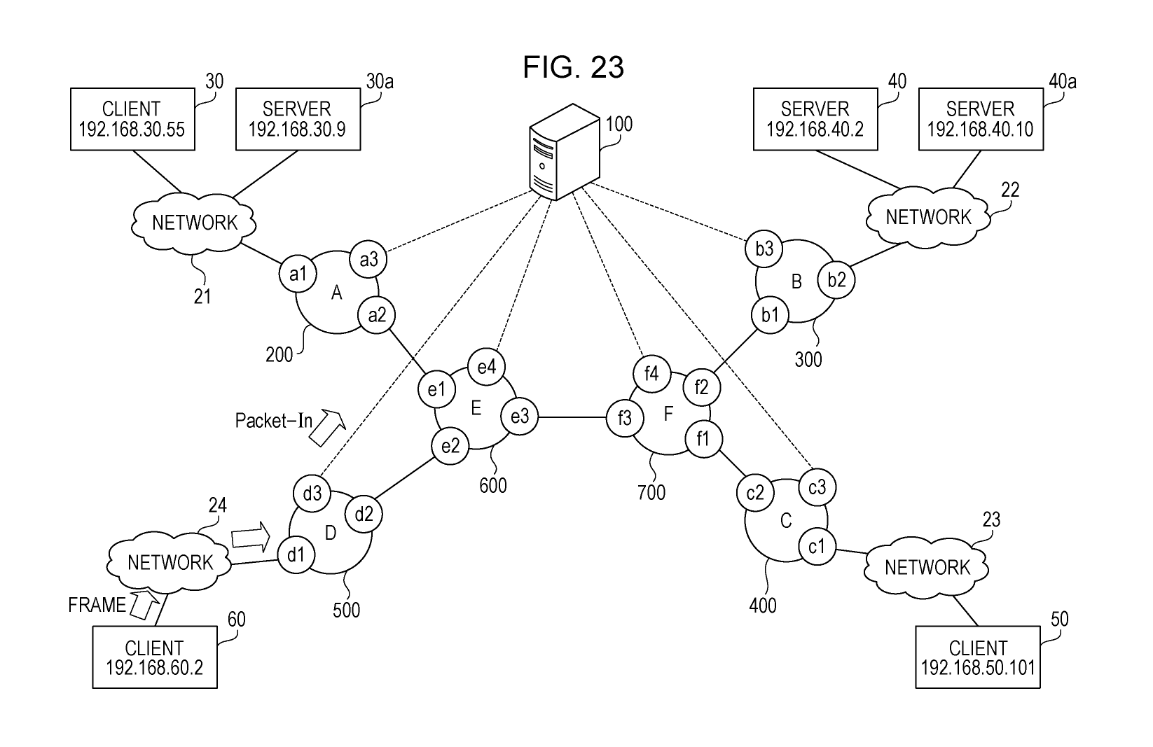

FIG. 22 is a flowchart illustrating an example of processing a frame other than the ARP according to the second embodiment. The frame assumed to be used here is a frame other than the ARP (this is true also in FIGS. 23 to 26). The processing illustrated in FIG. 22 is described below in order of increasing operation number.

An operation S31 is described below. The message communication unit 120 receives the packet-in message from any edge. The packet-in message includes a predetermined frame (that is, a frame other than the ARP request or the ARP response). As the frame, a frame is considered in which user data (for example, a server's request for a predetermined application, a response including a result of processing by the application or the like) is included in an IP packet. The address learning unit 130 and the transfer controller 150 obtain the packet-in message from the message communication unit 120.

An operation S32 is described below. The address learning unit 130 obtains the transmission source IP address from a header of the IP packet that is included in the frame. The address learning unit 130 refers to the address edge correspondence table 113 and thus determines whether or not information indicating the IP address space including the transmission source IP address is present. If such information is not present, the processing proceeds to an operation S33. If such information is present, the processing proceeds to an operation S34.

The operation S33 is described below. The address learning unit 130 generates information indicating the correspondence relationship between the transmission IP address of the obtained frame, the transmission source MAC address, and the edge information that is specified from the packet-in message, and adds the generated information to the end host table 112. Based on the policy information 111 and the information added to the end host table 112, the policy processing unit 140 adds a new entry to the address edge correspondence table 113. For example, it is assumed that the frame transmitted by the client 60 arrives at the switch 500 and the packet-in message including the frame is received. In this case, the policy processing unit 140 generates information indicating the correspondence relationship between the edge information “D-d1” and the IP address space “192.168.60.0/24” and adds the generated information to the address edge correspondence table 113. Then, the processing proceeds to the operation S34.

The operation S34 is described below. The transfer controller 150 obtains the destination IP address from the header of the IP packet that is included in the frame. The transfer controller 150 refers to the address edge correspondence table 113 and thus determines whether or not information indicating the IP address space including the destination IP address is present. If such information is present, the processing proceeds to an operation S35. If such information is not present, the processing proceeds to an operation S37.

The operation S35 is described below. The transfer controller 150 obtains from the address edge correspondence table 113 the edge information corresponding to the IP address space, which is searched for in the operation S34. The transfer controller 150 specifies the switches to pass through before arriving finally at the edge (end point edge) corresponding to the edge information from the transmission source edge (start point edge) of the packet-in. The specification method is as described in the operation S15. The transfer controller 150 assigns to each specified switch the flow entry for causing the frame to arrive at the end point edge from the start point edge. At this time, the transfer controller 150 performs the assignment on the end point edge in such a manner that with the edge information, the frame is output from the specified port.

An operation S36 is described below. The transfer controller 150 transmits the packet-out message including the obtained frame to the transmission source edge of the packet-in through the message communication unit 120. Then, the processing ends. In addition, according to the flow entry that is assigned in the operation S35, the edge that receives the packet-out message transfers the frame that is included in the packet-out message. According to the assigned flow entry, other switches also transfer the frame. Then, the processing ends.

The operation S37 is described below. The transfer controller 150 determines that the communication fails. This is because it is unclear which edge the frame has to be transferred to. For example, for recording, the transfer controller 150 may add detailed information on the communication failure to a predetermined log that is stored in the storage unit 110. Then, the processing ends.

In addition, the control server 100 may execute the operations S32 and S33 after the operations S34 to S37 or in parallel with the operations S34 to S37.

FIG. 23 is a diagram illustrating an example (an example 3) of the packet-in according to the second embodiment. In FIG. 23, in addition to the assumption in FIG. 21, it is assumed that a predetermined frame other than the ARP is transmitted from the client 60. The transmission source MAC address of the frame is the MAC address of the client 60. The transmission source IP address is “192.168.60.2”. The destination MAC address is the MAC address of the server 40a. The destination IP address is “192.168.40.10”.

The frame arrives at the port d1 over the network 24. Because the switch 500 does not retain the flow entry that is consistent with the frame, the switch 500 transmits the packet-in message including the frame to the control server 100.

When this is done, the control server 100 detects that the IP address space “192.168.60.0/24” is present in front of the port d1 of the switch 500. The control server 100 registers the correspondence relationship between the edge information “D-d1” and the IP address space “192.168.60.0/24” in the address edge correspondence table 113a.

Moreover, the control server 100 refers to the address edge correspondence table 113a and thus detects that the information indicating the IP address space “192.168.40.0/24” including the destination IP address “192.168.40.10” of the frame has been registered. The control server 100 determines that the frame is output (that is, is transferred to the network 22) from the port b2 (which is equivalent to the edge information “B-b2”) of the switch 300 corresponding to the IP address space.

Then, the control server 100 assigns the flow entry for transferring the frame to the network 22 to the switches 300, 500, 600, and 700. For example, the matching condition for specifying the frame is set to be “destination IP address: 192.168.40.10”. The action varies from one switch to another. In the switch 500, the designated output port is the port d2. In the switch 600, the designated output port is the port e3. In the switch 700, the designated output port is the port f2. In the switch 300, the designated output port is the port b2. At this point, the post-update address edge correspondence table 113a and the post-update flow table of each switch are as follows.

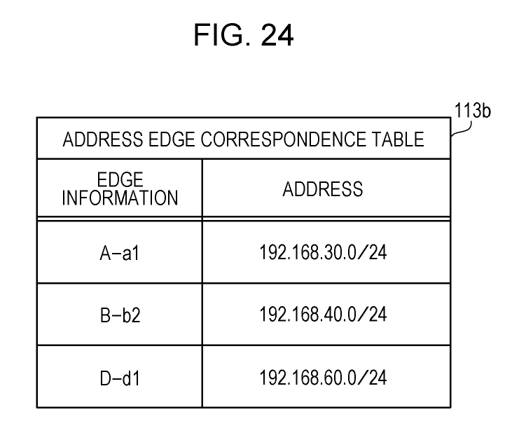

FIG. 24 is a diagram illustrating an example of the post-update table according to the second embodiment. The address edge correspondence table 113b illustrates the post-update address edge correspondence table 113a. The information indicating the correspondence relationship between the edge information “D-d1” and the IP address space “192.168.60.0/24” is added to the address edge correspondence table 113b.

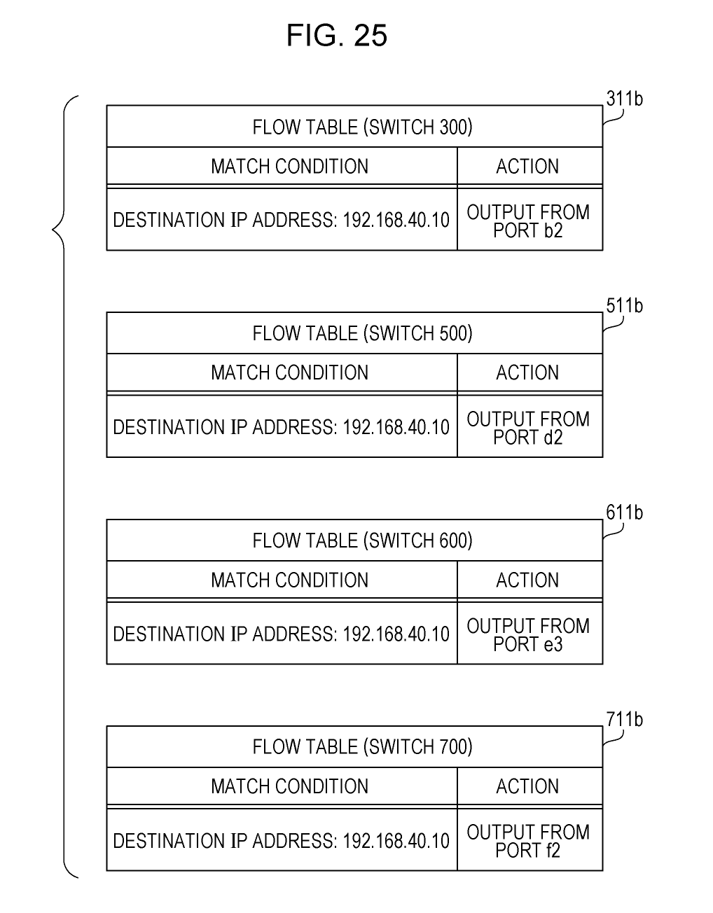

FIG. 25 is a diagram illustrating an example (a continuation example) of the post-update table according to the second embodiment. Flow tables 311b, 511b, 611b, and 711b illustrate the post-update flow tables 311a, 511a, 611a, and 711a, respectively. However, in FIG. 25, only the added flow entry is illustrated (illustrating of the other flow entries is omitted).

In any case, the matching condition of the added flow entry is commonly “destination IP address: 192. 168.40.10”. On the other hand, the action varies from one flow table after another. In the flow table 311b, the action is “output from the port b2”. In the flow table 511b, the action is “output from the port d2”. In the flow table 611b, the action is “output from the port e3”. In the flow table 711b, the action is “output from the port f2”.

Thereafter, the control server 100 transmits the packet-out message including the transfer target frame to the switch 500.

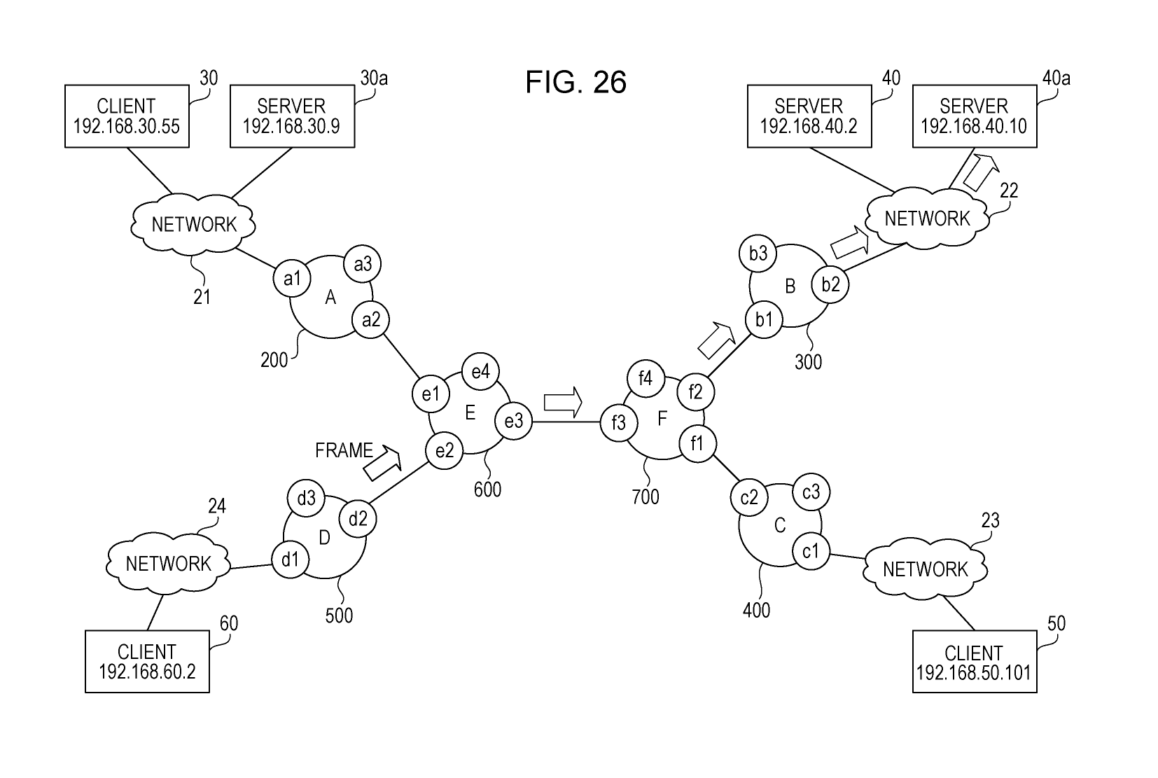

FIG. 26 is a diagram illustrating an example of transferring the frame according to the second embodiment. FIG. 26 illustrates a situation where the frame is transferred based on the flow table of each switch illustrated in FIG. 25. The frame is transferred from the switch 500 to the network 22 through the switches 600, 700, and 300 in this order. Thereafter, the frame is transferred to the server 40a over the network 22 based on the destination MAC address. In this manner, the data transmitted by the client 60 is transferred to the server 40a.

As described above, the control server 100 may improve the efficiency of the address learning. Such an improvement is described in detail as follows. For example, it is also considered that the control server 100 learns the correspondence relationship to the port of each switch for every IP address of the end host. However, in this case, when the learning is performed for every IP address, the greater the number of the end hosts, the greater the amount of address learning that the control server 100 practices. That is, the frequency with which the control server 100 practices the learning or the amount of information that the control server 100 learns increases.

When the frequency with which the control server 100 practices the learning increases, a learning load to the control server 100 may increase. Furthermore, because an amount of learned information greatly increases, a storage area such as the RAM 102 may run out of storage space. Furthermore, when the learning is performed for every IP address or for every MAC address and thus the number of the entries of the end host table 112 increases, a processing cost for searching the entries for any entry may increase.

Moreover, for example, it is also considered that each time an unknown IP address occurs (for example, each time the ARP request for an unknown IP address is received from the end host), the ARP request is transferred to multiple networks outside of the network 20. This is because with the ARP reply, the correspondence between the IP address and the port of the switch may be learned.

However, in this case, there is a concern that the number of the rules assigned to each switch will increase. This is because the flow entry for transferring the ARP request to multiple networks (networks 21, 22, 23, 24 and the like) is assigned to the switches 200, 300, 400, 500, 600, and 700 for every inquiry target IP address. When a size of the flow table of each switch increases, the storage area of each switch, such as the RAM, may run out of storage space. Furthermore, the processing cost for comparing the transfer target frame against the flow entry in each switch may increase.

Accordingly, the control server 100 learns which port of which switch the end host that has the IP address which belongs to each IP address space is present in front of, in a unit of the IP address space that is specified with the policy information 111. Then, the control server 100 registers the correspondence relationship between the edge information and the IP address space in the address edge correspondence table 113.

Thereafter, if the frame of which the destination is set to be the IP address that belongs to any IP address space is received, the edge that outputs the frame and the port from which the frame is output are determined based on the address edge correspondence table 113. That is, if the correspondence relationship between a certain IP address and the edge information may be detected, the control server 100 learns the correspondence relationship between the IP address space to which the IP address belongs and the edge information. Therefore, the edge information relating to any other IP address that belongs to the IP address space does not have to be learned. Consequently, the amount of address learning that the control server 100 practices may be decreased. The decrease in the amount of learning contributes to a decrease in the learning load, storage area saving, and a decrease in the processing cost for searching the learned information.

Furthermore, even when the ARP request is transferred, if the IP address space to which the destination IP address belongs is registered in the address edge correspondence table 113, the control server 100 may obtain the edge information corresponding to the IP address space. In this case, the ARP request may be transferred to the edge that is specified with the edge information, and the ARP request does not have to be transferred to other edges. For this reason, the switch not in use for the ARP transfer ends up without the unnecessary flow entry for transferring the ARP request being assigned to it. Consequently, the number of the flow entries assigned to each switch may be decreased. Furthermore, each switch ends up without the unnecessary transfer processing being performed on it, and for this reason, the load on the switch may be decreased. Moreover, the networks 21, 22, 23, and 24 also end up without performing unnecessary broadcasts at the user side. For this reason, the load on the networks 21, 22, 23, and 24 may be decreased as well

Moreover, the user may register the information indicating the IP address space that is intended to be learned, as the policy information 111 in advance in the storage unit 110. For example, in the networks 21, 22, 23, and 24, an operational policy that multiple end hosts which have adjacent IP addresses are connected to one network is present. When this is the case, if the user gets a full understanding of the policy, a set of addresses may be registered. In the example according to the second embodiment, the user may understand that “the IP address space that is defined with /24 belongs to a specific port of the same edge”. Therefore, the user ends up not being forced to assign the transfer rules for all the available destination IP addresses to the control server 100. Consequently, labor saving in the user operation is accomplished.

As described above, in the control server 100, the IP address space allocation policy is assigned in advance, the address edge correspondence table 113 that results from the conversion in which the policy is considered in addition to the learning information (end host table 112) that is obtained with the existing method is referred to, and thus the rule is assigned to each switch. As a result, the efficiency of the address learning may be improved.

In addition, the policy processing unit 140 refers to the end host table 112 and thus generates the entry of the address edge correspondence table 113, but may directly generate the entry from the packet-in message. In such a case, the policy processing unit 140 may obtain the edge information from the packet-in message, and may obtain the transmission source IP address from the IP header of the frame that is included in the packet-in message. Therefore, based on the policy information 111, the policy processing unit 140 may register in the address edge correspondence table 113 the correspondence relationship between the edge information and the IP address space to which the transmission source IP address belongs.

Furthermore, the matching condition that is assigned to the flow table of each switch is described above as being assigned in a unit of the destination IP address (for example, FIGS. 20 and 25), but may be assigned in a unit of the IP address space as described below.

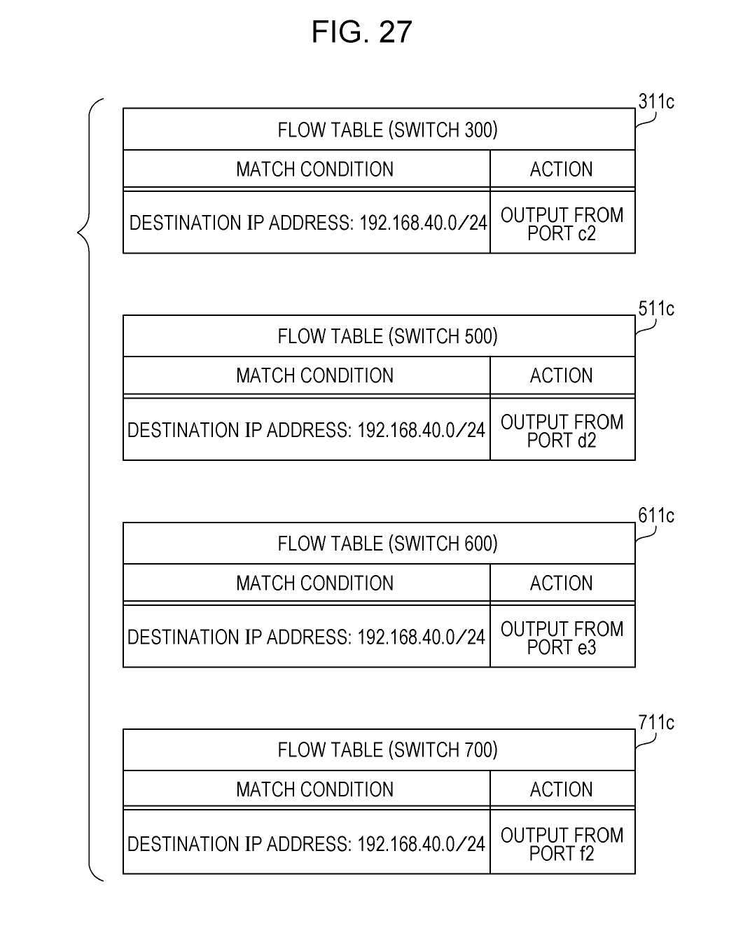

FIG. 27 is a diagram illustrating another example of the flow table according to the second embodiment. Instead of the flow entries that are indicated with the flow tables 311b, 511b, 611b, and 711b, the control server 100 may assign the flow entries that are indicated with the flow tables 311c, 511c, 611c, and 711c to the switches 300, 500, 600, and 700, respectively. Specifically, instead of using “destination IP address: 192.168.40.10”, the matching condition may be assigned using the IP address space such as “destination IP address: 192.168.40.0/24”.

In this case, the switches 500, 600, and 700 determine whether or not the destination IP address of the frame belongs to the IP address space “192.168.40.0/24”, and if so, then transfer the frame to the switch 300. In the same manner, the switch 300 determines whether or not the destination IP address of the frame belongs to the IP address space “192.168.40.0/24”, and if so, then outputs the frame from the port b2. For example, if the destination IP address does not belong to the IP address space, and there is nothing else that the flow entry is consistent with, the switches 300, 500, 600, and 700 inquire the processing method of the control server 100.

When this is done, the flow entry also may be used for the frame of which the destination is set to be a different IP address that belongs to the IP address space “192.168.40.0/24”. Therefore, the number of the flow entries that are registered with each switch may be further decreased. Furthermore, amounts of messages, such as the packet-in messages, the packet-out messages, or the flow-mod messages, that are transmitted and received between the control server 100 and each switch, may be decreased, compared with a case where the flow entry is assigned in a unit of the destination IP address. Consequently, the load on the control server 100 or on each switch may be decreased. Furthermore, the load on the networks 10 and 20 may be decreased as well.

### Third Embodiment

A third embodiment is described below. Descriptions are provided below with focus on what distinguishes the third embodiment from the second embodiment, and descriptions of common matters are not repeated.

According to the second embodiment, when the ARP request of which the destination is set to be the IP address that belongs to the learning-finished IP address space is transferred, the packet-out message is transmitted to the transmission source edge of the packet-in (the operations S15 and S17 in FIG. 14).

On the other hand, other methods are also considered for transferring the ARP request within the network 20. For example, the edge information corresponding to the IP address space is registered in the address edge correspondence table 113. Accordingly, the control server 100 may transmit the packet-out message including the ARP request to the edge that is specified with the edge information. According to the third embodiment, such a function is provided.

At this point, an information processing system according to the third embodiment is the same as the information processing system according to the second embodiment, which is described referring to FIGS. 2 and 3. Furthermore, hardware and a functional example of a control server or a switch according to the third embodiment are the same as the hardware and the functional example of the control server 100 or the switch 200 according to the second embodiment, which are described referring to FIGS. 4 to 7. Accordingly, names and reference numerals that are used according to the third embodiment are the same as the names and the reference numerals that are used according to the second embodiment. The third embodiment is different from the second embodiment in that instead of the processing operations illustrated in FIGS. 14 and 17, the following processing operations are executed on the ARP request.

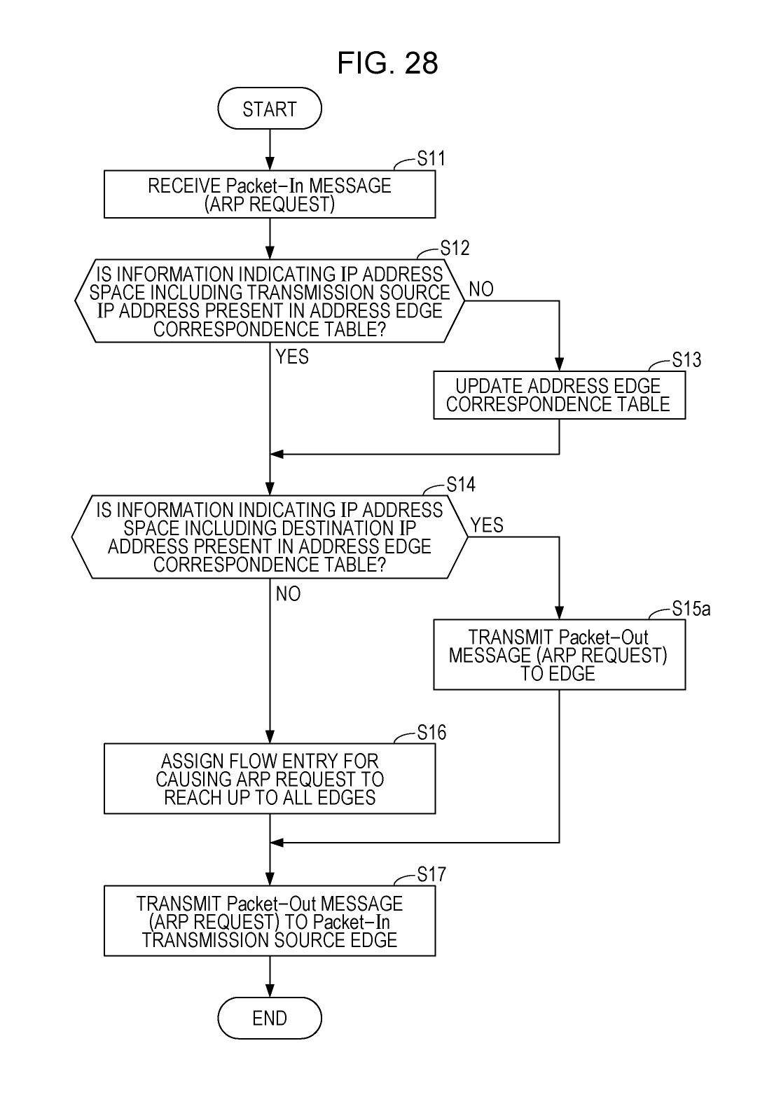

FIG. 28 is a flowchart illustrating a processing example that is performed in a case of the ARP request, according to the third embodiment. The processing illustrated in FIG. 28 is described below in order of increasing operation number. At this point, FIG. 28 is different in processing operations from the FIG. 14 in that instead of the operation S15, an operation S15a is executed (the other operations are the same as those in FIG. 14). Accordingly, the operation S15a is described below and descriptions of the other operations are not repeated. If it is determined in the operation S14 that the information indicating the IP address space including the destination IP address is present in the address edge correspondence table, the operation S15a is executed.

The operation S15a is described below. The transfer controller 150 obtains from the address edge correspondence table the edge information corresponding to the IP address space, which is searched for in the operation S14. The transfer controller 150 transmits the packet-out message including the received ARP request to the edge that is specified with the edge information. At this time, the transfer controller 150 assigns the flow entry for outputting the ARP request from the port that is specified with the edge information, in advance to the edge. Then, the processing ends.

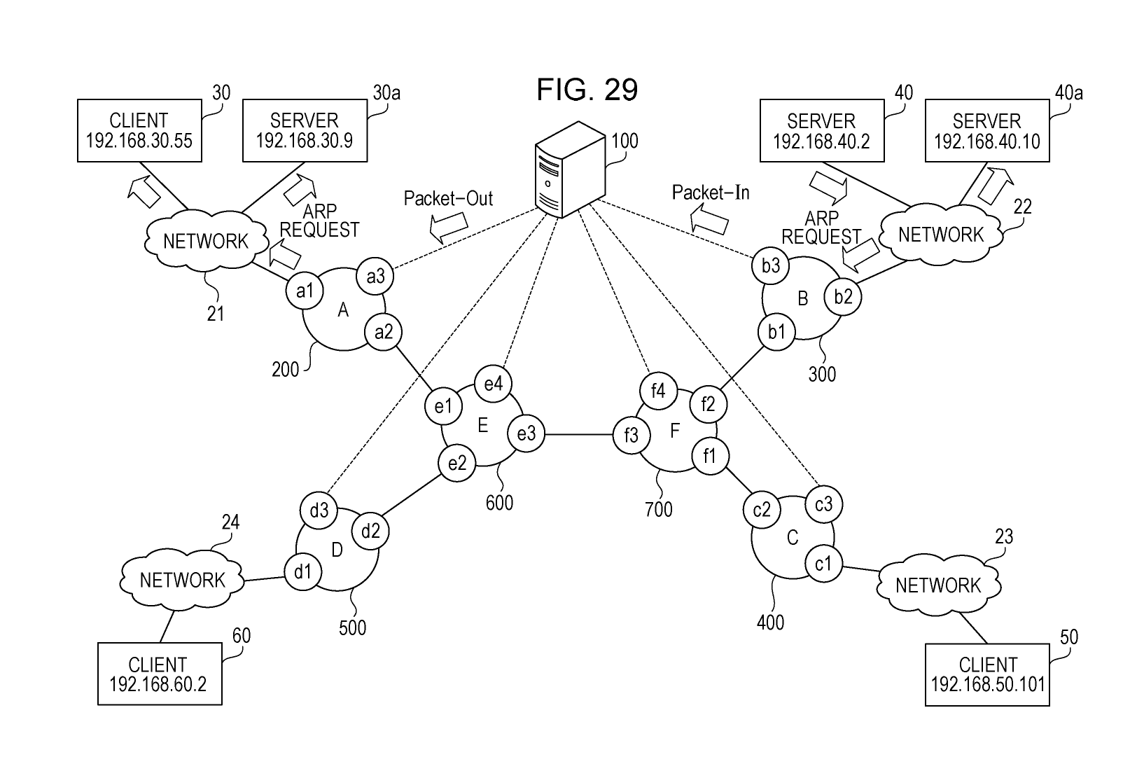

FIG. 29 is a diagram illustrating an example of transferring the ARP request according to the third embodiment. In FIG. 29, it is assumed that the control server 100 retains the address edge correspondence table 113a illustrated in FIG. 19, and the ARP request of which the destination IP address is set to be “192.168.30.9” is transmitted from the server 40. The flow entry that is consistent with the ARP request is set not to be registered in the flow table of each switch.

The ARP request transmitted from the server 40 is broadcast within the network 22 and arrives at the server 40a and the port b2. The server 40a ignores the ARP request. This is because the destination IP address “192.168.30.9” is not the IP address of the server 40a.

Because the flow entry that is consistent with the ARP request is not retained, the switch 300 transmits the packet-in message including the ARP request to the control server 100.

The control server 100 receives the packet-in message. The edge information “B-b2” and the IP address space “192.168.40.0/24” have been registered in the address edge correspondence table 113a (the learning is finished). Therefore, the control server 100 does not perform the learning of the IP address space.

The control server 100 refers to the address edge correspondence table 113a and thus detects that the information indicating the IP address space “192.168.30.0/24” that includes the destination IP address “192.168.30.9” of the ARP request has been registered. The control server 100 determines that the ARP request is output (that is, is transferred to the network 21) from the port a1 (which is equivalent to the edge information “A-a1”) of the switch 200 corresponding to the IP address space.

Then, the control server 100 assigns the flow entry for outputting the ARP request from the port a1 to the switch 200. The control server 100 transmits the packet-out message including the ARP request to the switch 200.

When the packet-out message is received from the control server 100, the switch 200 extracts the ARP request that is included in the packet-out message, and outputs the extracted ARP request from the port a1 according to the flow entry. When the ARP request arrives at the network 21, the ARP request is broadcast over the network 21. Even though the ARP request is received, the client 30 ignores the ARP request. This is because the destination IP address that is included in the ARP request is not the IP address of the client 30. When the ARP request is received, the server 30a generates the ARP reply to respond to the ARP request. This is because the destination IP address that is included in the ARP request is the IP address of the server 30a.

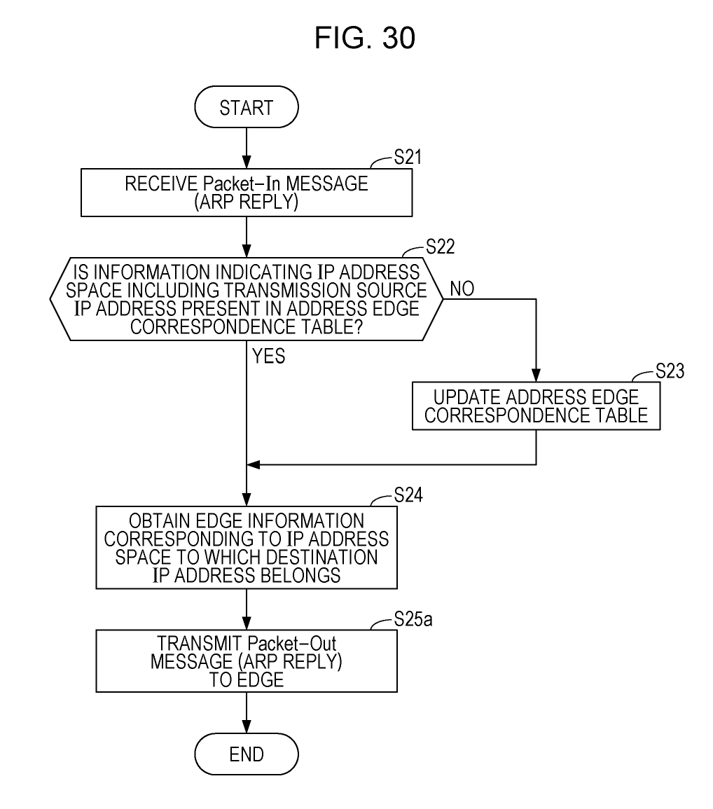

FIG. 30 is a flowchart illustrating an example of processing that is performed in the case of the ARP reply according to the third embodiment. The processing illustrated in FIG. 30 is described below in order of increasing operation number. At this point, FIG. 30 is different in processing operations from FIG. 17 in that instead of the operations S25 and S26, an operation S25a is executed (the other operations are the same as those in FIG. 17). Accordingly, the operation S25a is described below and descriptions of the other operations are not repeated. The operation S25a is executed after the operation S24.

The operation S25a is described below. The packet-out message including the received ARP reply is transmitted to the edge that is specified with the edge information which is obtained in the operation S24. At this time, the transfer controller 150 assigns the flow entry for outputting the ARP reply from the port that is specified with the edge information, in advance to the edge. Then, the processing ends.

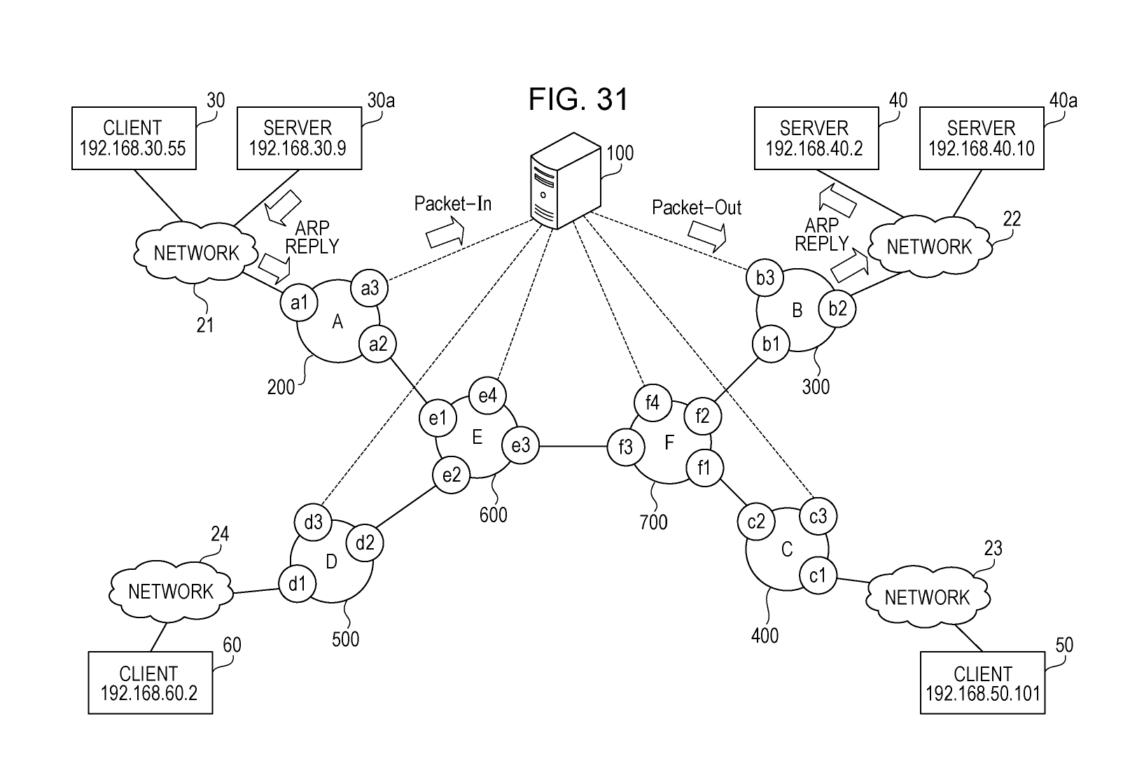

FIG. 31 is a diagram illustrating an example of transferring the ARP reply according to the third embodiment. In FIG. 31, in addition to the assumption in FIG. 29, it is assumed that the ARP reply is transmitted from the server 30a. The ARP reply arrives at the port a1 over the network 21. Because the switch 200 does not retain the flow entry that is consistent with the ARP reply, the switch 200 transmits the packet-in message including the ARP reply to the control server 100.

The control server 100 receives the packet-in message. The edge information “A-a1” and the IP address space “192.169.30.0/24” have been registered in the address edge correspondence table 113a (the learning is finished). Therefore, the control server 100 does not perform the learning of the IP address space.

The control server 100 refers to the address edge correspondence table 113a and thus detects that the information indicating the IP address space “192.168.40.0/24” including the destination IP address “192.168.40.2” of the ARP reply has been registered. The control server 100 determines that the ARP reply is output (that is, is transferred to the network 22) from the port b2 (which is equivalent to the edge information “B-b2”) of the switch 300 corresponding to the IP address space.

Then, the control server 100 assigns the flow entry for outputting the ARP request from the port b2 to the switch 300. Thereafter, the control server 100 transmits the packet-out message including the ARP reply to the switch 300.

When the packet-out message is received from the control server 100, the switch 300 extracts the ARP reply that is included in the packet-out message, and outputs the extracted ARP reply from the port b2 according to the flow entry. The ARP reply is transferred to the server 40 over the network 22. The server 40 may specify the transmission source MAC address that is included in the ARP reply, as the MAC address corresponding to the IP address “192.168.30.9”. In addition, the flow tables of the switches 200 and 300 at the time of the transfer of the ARP request in FIGS. 29 and 31, respectively, are as follows.

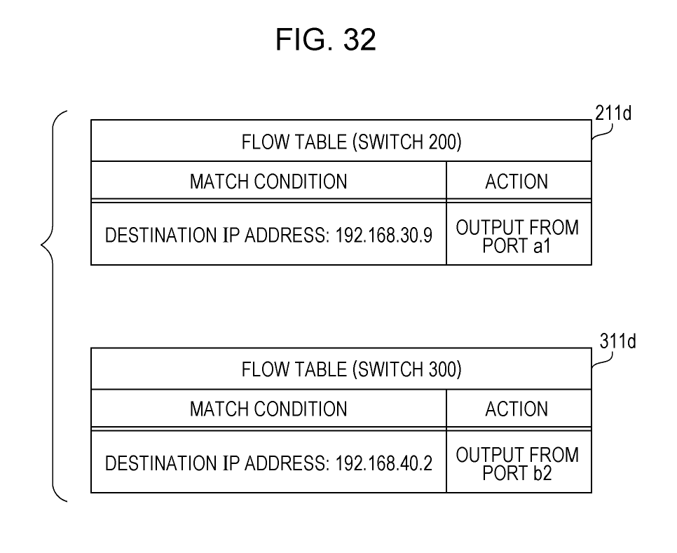

FIG. 32 is a diagram illustrating an example of a flow table according to the third embodiment. A flow table 211d is a flow table of the switch 200 at the time of the transfer of the ARP request in FIG. 29. However, FIG. 32 illustrates only the flow entry that is used for the transfer of the ARP request (illustrating of the other flow entries is omitted). For example, the matching condition “destination IP address: 192.168.30.9” and the action “output from the port a1” are assigned to the flow table 211d.

A flow table 311d is a flow table of the switch 300 at the time of the transfer of the ARP reply in FIG. 31. However, FIG. 31 illustrates only the flow entry that is used for the transfer of the ARP reply (illustrating of the other flow entries is omitted). For example, the matching condition “destination IP address: 192.168.40.2” and the action “output from the port b2” are assigned to the flow table 311d.

In this manner, according to the third embodiment, the control server 100 transmits the ARP request and the ARP reply directly to the edge that is specified with the address edge correspondence table. For this reason, the flow entry for transferring the ARP request or the ARP reply may not be assigned to the switches 600 and 700. Furthermore, because the switches 600 and 700 end up without performing ARP transfer, the load on the switches 600 and 700 may be decreased.

In addition, the control server 100 may include the action responding to the ARP request or the ARP reply in the packet-out message. For example, in the operation S15a in FIG. 28 and the operation S25 in FIG. 30, the transfer controller 150 may include the action to specify the output port in the packet-out message. In such a case, the transfer controller 150 does not have to assign the flow entry separately to the switches 200 and 300 using the flow-mod message.

Furthermore, each switch described up to this point sends the packet-in message to the control server 100 if the flow entry for transferring the ARP request or reply is not retained. On the other hand, the control server 100 may assign the flow entry for transmitting the frame of which an Ethernet type of the MAC header is “0x0806 (ARP)” to the control server 100, in advance to each edge.

### Fourth Embodiment

A fourth embodiment is described below. Descriptions are provided below with focus on what distinguishes the fourth embodiment from the second and third embodiments, and descriptions of common matters are not repeated.

Other methods are further considered for transferring the ARP request within the network 20. Specifically, the control server 100 may respond with an arbitrary MAC address in response to the ARP request received from an inquiry source end host. This is because routing according to the MAC address may be performed within the network 20. According to the fourth embodiment, such a function is provided.

At this point, an information processing system according to the fourth embodiment is the same as the information processing system according to the second embodiment, which is described referring to FIGS. 2 and 3. Furthermore, hardware and a functional example of a control server or a switch according to the fourth embodiment are the same as the hardware and the functional example of the control server 100 or the switch 200 according to the second embodiment, which are described referring to FIGS. 4 to 7. Accordingly, names and reference numerals that are used according to the fourth embodiment are the same as the names and the reference numerals that are used according to the second embodiment. The fourth embodiment is different from the second embodiment in that instead of the processing operations illustrated in FIGS. 14 and 17, the following processing operations are executed on the ARP request.

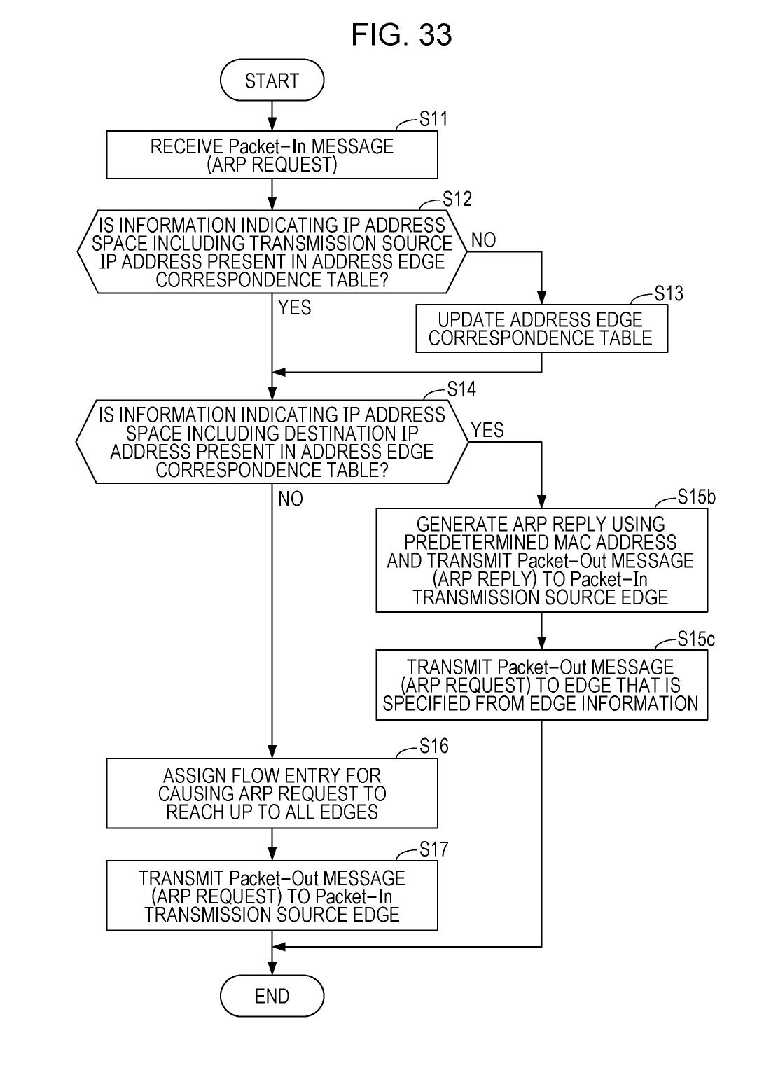

FIG. 33 is a flowchart illustrating a processing example that is performed in the case of the ARP request, according to the fourth embodiment. The processing illustrated in FIG. 33 is described below in order of increasing operation number. At this point, FIG. 33 is different in processing operations from FIG. 14 in that instead of the operation S15, operations 515b and 515c are executed (the other operations are the same as those in FIG. 14). Accordingly, the operations 515b and 515c are described below and descriptions of the other operations are not repeated. If it is determined in the operation S14 that the information indicating the IP address space including the destination IP address of the ARP request is present in the address edge correspondence table, the operation S15b is executed.

The operation S15b is described below. The transfer controller 150 generates the ARP reply using a predetermined MAC address. The transfer controller 150 transmits the packet-out message including the generated ARP reply to the transmission source edge of the packet-in. At this time, the transfer controller 150 assigns the flow entry for outputting the ARP reply from the port that receives the ARP request, in advance to the transmission source edge of the packet-in. In addition, with the ARP reply, the user may arbitrarily determine which MAC address to respond with. For example, the MAC address of the transmission source edge of the packet-in may be possible, and other MAC addresses may be possible.

The operation S15c is described below. The transfer controller 150 obtains from the address edge correspondence table the edge information corresponding to the IP address space, which is searched for in the operation S14. The transfer controller 150 transmits the packet-out message including the received ARP request to the edge that is specified with the edge information. At this time, the transfer controller 150 assigns the flow entry for outputting the ARP request from the port that is specified with the edge information, in advance to the edge. Furthermore, the transfer controller 150 assigns to the edge the flow entry (flow entry for obtaining the ARP reply from the edge) for transmitting the ARP reply to the control server 100 if the ARP reply to the ARP request is received by the edge. Then, the processing ends.

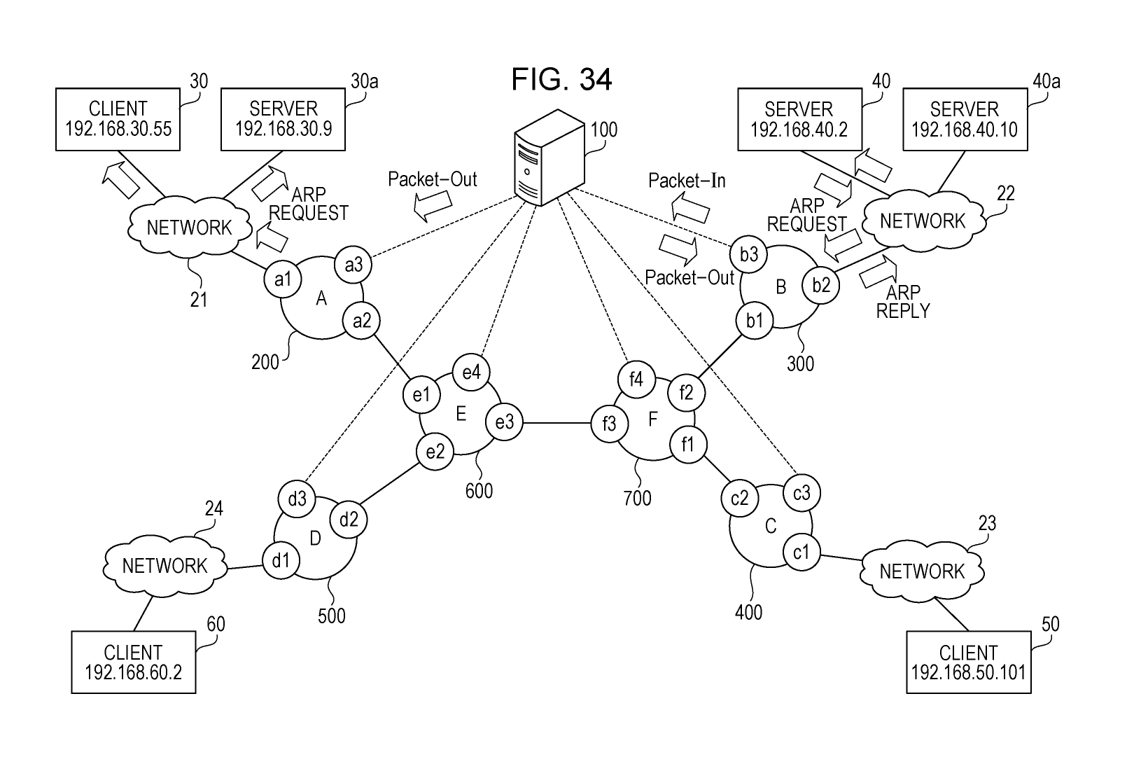

FIG. 34 is a diagram illustrating an example of transferring the ARP request according to the fourth embodiment. In FIG. 34, it is assumed that in a state where the control server 100 retains the address edge correspondence table 113a illustrated in FIG. 19, the ARP request of which the destination IP address is set to be “192.168.30.9” is transmitted from the server 40. The flow entry that is consistent with the ARP request is set not to be registered in the flow table of each switch.

The ARP request transmitted from the server 40 is broadcast within the network 22 and arrives at the server 40a and the port b2. However, in FIG. 34, illustrating of an arrow indicating the ARP request that arrives at the server 40a is omitted. The server 40a ignores the ARP request. This is because the destination IP address “192.168.30.9” is not the IP address of the server 40a.

Because the flow entry that is consistent with the ARP request is not retained, the switch 300 transmits the packet-in message including the ARP request to the control server 100.

The control server 100 receives the packet-in message. The edge information “B-b2” and the IP address space “192.168.40.0/24” have been registered in the address edge correspondence table 113a (the learning is finished). Therefore, the control server 100 does not perform the learning of the IP address space.

The control server 100 refers to the address edge correspondence table 113a and thus detects that the information indicating the IP address space “192.168.30.0/24” that includes the destination IP address “192.168.30.9” of the ARP request has been registered.

When this is done, the control server 100 generates the ARP reply that responds to the MAC address of the switch 300. The control server 100 assigns the flow entry for outputting the ARP reply from the port b2 to the switch 300. The control server 100 transmits the packet-out message including the ARP reply to the switch 300.

When the packet-out message is received from the control server 100, the switch 300 extracts the ARP reply that is included in the packet-out message, and outputs the extracted ARP reply from the port b2 according to the flow entry. The ARP reply is transferred to the server 40 over the network 22. The server 40 may specify the transmission source MAC address (here, the MAC address of the switch 300) that is included in the ARP reply, as the MAC address corresponding to the IP address “192.168.30.9”.

Moreover, the control server 100 determines that the ARP request is output (that is, is transferred to the network 21) from the port a1 (which is equivalent to the edge information “A-a1”) of the switch 200 corresponding to the IP address space “192.168.30.0/24”.

Then, the control server 100 assigns the flow entry for outputting the ARP request from the port a1 to the switch 200. Furthermore, if the switch 200 receives the ARP reply to the ARP request, the control server 100 assigns to the switch 200 the flow entry for transmitting the ARP reply to the control server 100. The control server 100 transmits the packet-out message including the ARP request to the switch 200.

When the packet-out message is received from the control server 100, the switch 200 extracts the ARP request that is included in the packet-out message, and outputs the extracted ARP request from the port a1 according to the flow entry. When the ARP request arrives at the network 21, the ARP request is broadcast over the network 21. Even though the ARP request is received, the client 30 ignores the ARP request. This is because the destination IP address that is included in the ARP request is not the IP address of the client 30. When the ARP request is received, the server 30a generates the ARP reply to respond to the ARP request. This is because the destination IP address that is included in the ARP request is the IP address of the server 30a.

In addition, in FIG. 34, the flow entry that is used for the transfer of the ARP request and the ARP reply is the same as the one illustrated in FIG. 32. However, for example, the flow entry indicating “A frame with the Ethernet type: 0x0806 (ARP), transmission source IP address: 192.168.30.9 (the IP address of the server 30a) is sent out to the control server 100” may be assigned to the switch 200. This is the flow entry for providing the ARP reply to the control server 100 from the server 30a.

Furthermore, as described referring to FIG. 32, with the packet-out message, the control server 100 may instruct the switches 200 and 300 to designate the output port for the ARP request or the ARP reply.

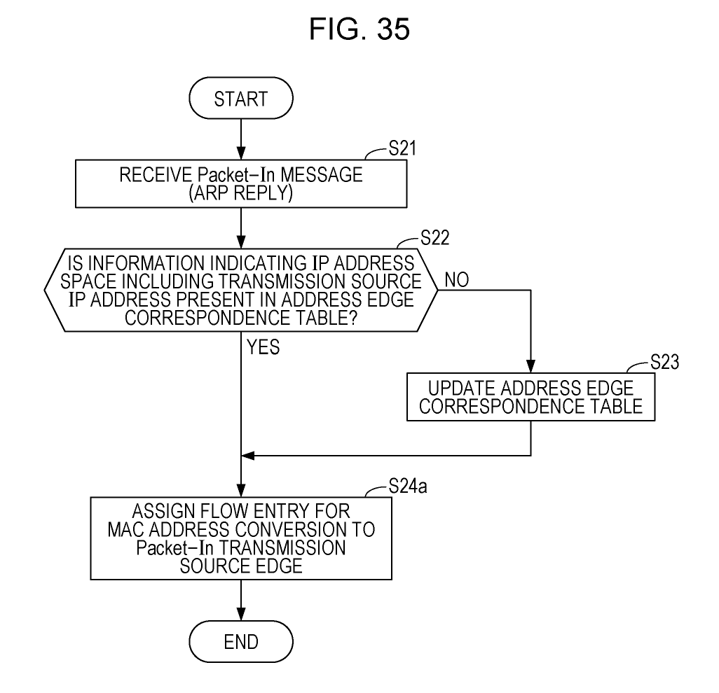

FIG. 35 is a flowchart illustrating an example of processing that is performed in the case of the ARP reply according to the fourth embodiment. The processing illustrated in FIG. 35 is described below in order of increasing operation number. At this point, FIG. 35 is different in processing operations from FIG. 17 in that instead of the operations S24 to S26, an operation S24a is executed (the other operations are the same as those in FIG. 17). Accordingly, the operation S24a is described below and descriptions of the other operations are not repeated. If it is determined in the operation S22 that the information indicating the IP address space including the transmission source IP address of the ARP reply is present in the address edge correspondence table, or after the operation S23 is executed, the operation S24a is executed.

The operation S24a is described below. The transfer controller 150 assigns the flow entry for MAC address conversion to the transmission source edge of the packet-in. Specifically, the transfer controller 150 extracts the transmission source MAC address and the transmission source IP address from the received ARP reply. Then, for a frame of which the destination IP address is set to be the IP address that is extracted from the ARP reply, the transfer controller 150 assigns to the edge the flow entry for converting the destination MAC address of the frame to the MAC address extracted from the ARP reply. Then, the processing ends.

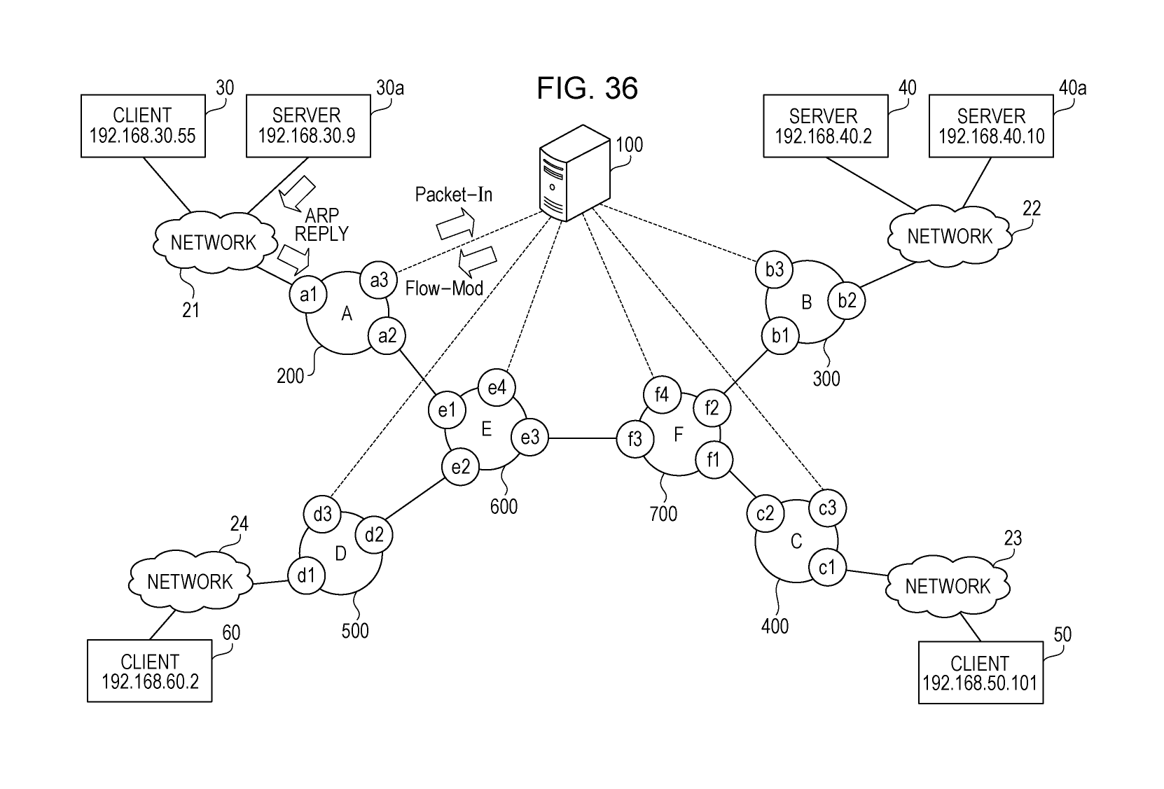

FIG. 36 is a diagram illustrating an example of transferring the ARP reply according to the fourth embodiment. In FIG. 36, in addition to the assumption in FIG. 34, it is assumed that the ARP reply is transmitted from the server 30a. The ARP reply arrives at the port a1 over the network 21. According to the flow entry, the switch 200 transmits the packet-in message including the ARP reply to the control server 100.

The control server 100 receives the packet-in message. The edge information “A-a1” and the IP address space “192.169.30.0/24” have been registered in the address edge correspondence table 113a (the learning is finished). Therefore, the control server 100 does not perform the learning of the IP address space.

The control server 100 extracts the transmission source MAC address (the MAC address of the server 30a) and the transmission source IP address (in this case, “192.168.30.9”) from the obtained ARP reply. Then, the control server 100 assigns the flow entry for the MAC address conversion to the switch 200. In this example, the control server 100, as illustrated in FIG. 34, responds with the MAC address of the switch 300 to the server 40. Therefore, when the communication is performed with the destination IP address “192.168.30.9” being designated, the server 40 assigns the MAC address of the switch 300, as the destination MAC address, to the MAC header of the frame.

For this reason, the control server 100 assigns to the switch 200 the flow entry for converting the destination MAC address of the frame including the destination IP address “192.168.30.9” to the MAC address of the server 30a (changing of the existing flow entry may be possible). When this is done, the flow table that is retained by the switch 200 is as follows.

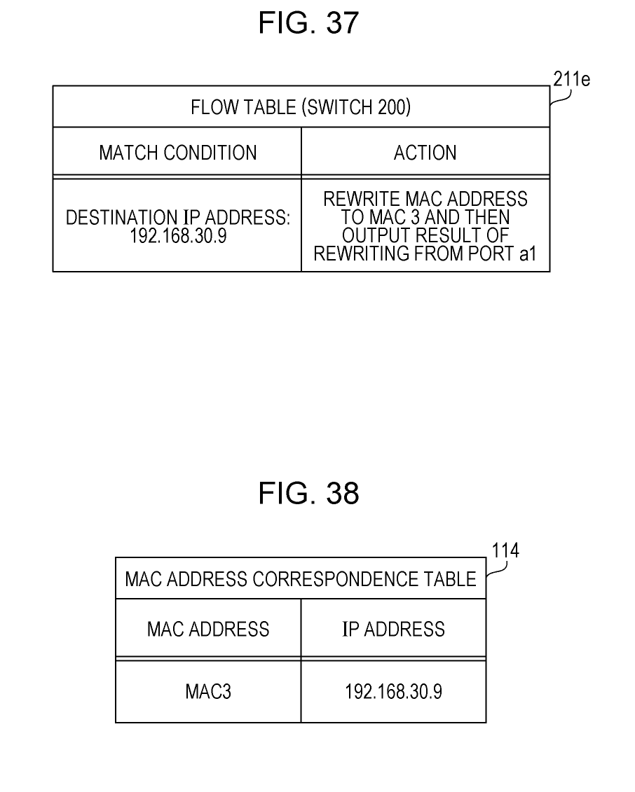

FIG. 37 is a diagram illustrating an example of a flow table according to the fourth embodiment. A flow table 211e is a flow table of the switch 200 that results when the flow entry for the MAC address conversion is added. However, only the added (or changed) flow entry is illustrated (illustrating of the other flow entries is omitted). For example, the matching condition “destination IP address: 192.168.30.9” and the action “rewrite the MAC address to MAC3 and then output result of rewriting from the port a1” are assigned to the flow table 211e. At this point, the “MAC3” is the MAC address of the server 30a.

In this manner, the control server 100 may provide the server 40 with the MAC address that is different from the MAC address of the server 30a. For example, it is also assumed that the information processing system further includes multiple switches, and multiple candidates are present on the communication path from the switch 300 to the switch 200. Such a case is useful in that the routing from the switch 300 to the switch 200 may be freely controlled using a predetermined MAC address provided to the server 40.

At this time, for the frame of which the destination is set to be the IP address of the server 30a, the control server 100 assigns to the switch 200 the flow entry for converting the destination MAC address to the MAC address of the server 30a. Accordingly, even though the MAC address that is different from the MAC address of the server 30a is provided to the server 40, the frame destined to the IP address of the server 30a, which is transmitted from the server 40, may be caused to arrive finally at the server 30a. In addition, based on the ARP reply, the control server 100 may record the correspondence relationship between the IP address of the end host and the MAC address as follows.

FIG. 38 is a diagram illustrating an example of a MAC address correspondence table according to the fourth embodiment. A MAC address correspondence table 114 is stored in the storage unit 110. The MAC address correspondence table 114 includes the items that are the MAC address and the IP address. The MAC address is registered in the MAC address item. The IP address is registered in the IP address item. For example, pieces of information that are the MAC address “MAC3”, and the IP address “192.168.30.9” are registered in the MAC address correspondence table 114. These are pieces of information that the control server 100 records based on the packet-in message (ARP reply) illustrated in FIG. 36.

For example, in the operation 515b in FIG. 33, based on the MAC address correspondence table 114, the control server 100 may determine the MAC address responding to the destination IP address of the ARP request. That is, if the same IP address as the destination IP address of the ARP request is registered in the MAC address correspondence table 114, the control server 100 may respond with the MAC address corresponding to the IP address. In this case, the operations S15c in FIG. 33 and the processing in FIG. 35 may be omitted.

In addition, as also described according to the third embodiment, the control server 100 may assign the flow entry for transmitting the frame of which the Ethernet type of the MAC header is “0x0806 (ARP)” to the control server 100, in advance to each switch. In such a case, in the operation S15c in FIG. 33, the control server 100 may not separately assign to the edge the flow entry for obtaining the ARP reply from the edge. Furthermore, while the ARP request is transferred using the methods according to the third and fourth embodiments, frames other than the ARP may be transferred properly to the destination using the processing operations in FIG. 22.

### Fifth Embodiment

A fifth embodiment is described below. Descriptions are provided below with focus on what distinguishes the fifth embodiment from the second to fourth embodiments, and descriptions of common matters are not repeated.

According to the second to fourth embodiments, it is illustrated that the control server 100 controls multiple switches. On the other hand, the control server 100 may control only one switch.

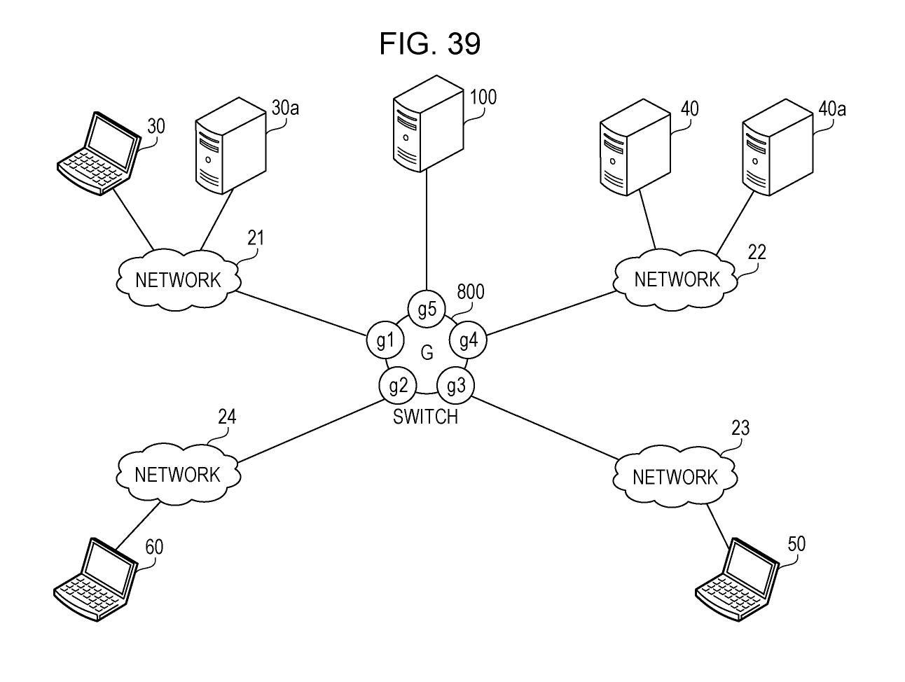

FIG. 39 is a diagram illustrating an information processing system according to the fifth embodiment. The information processing system according to the fifth embodiment is different from the information processing system according to the second embodiment, which is described referring to FIGS. 2 and 3, in that instead of the switches 200, 300, 400, 500, 600, and 700, the information processing system according to the fifth embodiment has a switch 800. In other respects other than this respect, the fifth embodiment is the same as the second embodiment. Hardware and a functional example of the switch 800 are the same as the hardware and the functional example of the switch 200 described referring to FIGS. 5 and 7.

The switch 800 has ports g1, g2, g3, g4, and g5. The port g1 is connected to the network 21. The port g2 is connected to the network 24. The port g3 is connected to the network 23. The port g4 is connected to the network 22. The port g5 is connected to the control server 100. In addition, the identification information on the switch 800 is “G”.

The control server 100 may control the switch 800 in the same manner as that according the second embodiment. For example, the control server 100 is set to obtain from the switch 800 the frame of which the transmission source is set to be the IP address “192.168.30.55” of the client 30. When this is done, based on the policy information 111, the control server 100 generates the information indicating the correspondence relationship between the edge information “G-g1” and the IP address space “192.168.30.0/24”. Then, the control server 100 registers the generated information in the address edge correspondence table 113.

Thereafter, for example, the control server 100 is set to obtain from the switch 800 the frame of which the destination is set to be the IP address “192.168.30.9” of the server 30a. When this is done, based on the address edge correspondence table 113, the control server 100 determines that the frame is output from the port g1 of the switch 800. In this manner, even though the edge information for “192.168.30.9” is not learned, the control server 100 may determine the transfer destination of the frame of which the destination is set to be “192.168.30.9”. Therefore, the efficiency of the address learning by the control server 100 may be improved in the same manner as according to the second embodiment.

In addition, according to the first to fifth embodiments, as the node and the end host, a physical computer (physical machine) may be used, and a virtual computer (virtual machine) that operates on the physical machine may be used. For example, software called a hypervisor realizes the virtual machine on the physical machine using a resource such as a CPU or a RAM on the physical machine.

Furthermore, the information processing according to the first embodiment may be realized by causing the processor, which is used as the controller 1b, to execute the program. The information processing according to the second to fifth embodiments may be realized by causing the processor 101 to execute the program. The program may be recorded in a computer-readable recording medium 13.

For example, the program may be circulated by distributing the recording media 13, on each of which the program is recorded. Furthermore, the program may be stored in a different computer and the program may be distributed over a network. The computer, for example, may store (install) the program recorded on the recording medium 13 or the program received from a different computer in a storage device such as a RAM 102 or the HDD 103 and may read and execute the program from the storage device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control apparatus that controls data transfer by a switch having a plurality of ports, the control apparatus comprising:
a storage in which information indicating a plurality of sets of addresses is stored; and
a controller configured to execute a procedure comprising:
obtaining a first address and information on a port that receives first data, from a first switch that receives the first data of which a transmission source is set to be the first address, the port being any one of the plurality of ports;
generating information indicating a correspondence relationship between a set to which the first address belongs, among the plurality of sets, and the port;
obtaining a second address from the first switch or a second switch that receives second data of which a destination is set to be the second address that belongs to any one of the plurality of sets; and
determining that the second data is output from the port, based on the correspondence relationship.

2. The control apparatus according to claim 1, the procedure further comprising:
when obtaining the second address from the second switch,
determining whether or not the second address belongs to the set by the second switch; and
if the second address belongs to the set,
assigning a rule that the second data is transferred toward the first switch, to a switch that is present on a communication path leading to the first switch from the second switch.

3. The control apparatus according to claim 1, the procedure further comprising:
determining whether or not the second address belongs to the set by the first switch; and
if the second address belongs to the set,
assigning to the first switch, a rule that the second data is output from the port.

4. The control apparatus according to claim 1,
wherein the set is a set of Internet Protocol (IP) addresses,
wherein the second data is an Address Resolution Protocol (ARP) request including the second address as a destination IP address, and
the procedure further comprising:
when obtaining the second address from the second switch,
assigning a rule that the ARP request is transferred toward the first switch, to a switch that is present on a communication path leading to the first switch from the second switch.

5. The control apparatus according to claim 1,
wherein the set is a set of IP addresses,
wherein the second data is an ARP request including the second address as a destination IP address, and
the procedure further comprising:
when obtaining the ARP request from the second switch,
transmitting the ARP request to the first switch.

6. The control apparatus according to claim 5,
wherein the destination IP address is an IP address of a node that is coupled to the port through a network, the node having a first MAC address associated with the IP address of the node, and
the procedure further comprising:
generating an ARP reply of which a transmission source MAC address is set to be a second MAC address different from the first MAC address, and
transmitting the generated ARP reply to the second switch.

7. The control apparatus according to claim 6, the procedure further comprising:
obtaining the ARP reply transmitted by the node in response to the ARP request, over the first switch;
obtaining the first MAC address from the ARP reply; and
assigning a rule that a destination MAC address of the second data including the destination IP address in the destination is converted to the first MAC address, to the first switch.

8. The control apparatus according to claim 1,
wherein policy information with which a method of allocating an address space is determined is stored in the storage, and
the procedure further comprising:
when obtaining the first address and the information on the port,
learning correspondence between the first address and the port;
converting the first address into an address space based on the policy information; and
generating information indicating correspondence between the address space and the port, and
when obtaining the second address,
assigning a rule for transferring the second data to the first switch or a switch that is present on a communication path leading to the first switch from the second switch by referring to the information indicating the correspondence.

9. A transfer control method of controlling data transfer by a switch having a plurality of ports, the transfer control method comprising:
obtaining a first address and information on a port that receives first data, from a first switch that receives the first data of which a transmission source is set to be the first address, the port being any one of the plurality of ports;
generating, by referring to information indicating each one of a plurality of sets of addresses, information indicating a correspondence relationship between a set to which the first address belongs, among the plurality of sets, and the port;
obtaining a second address from the first switch or a second switch that receives second data of which a destination is set to be the second address that belongs to any one of the plurality of set; and
determining that the second data is output from the port, based on the correspondence relationship.
